(19) United States
(12) Patent Application Publication
(10) Pub. No.: US 2022/0401959 A1
(43) Pub. Date: Dec. 22, 2022

(54) Dried Dye Reagent Devices and Methods for Making and Using The Same

(71) Applicant: Becton, Dickinson and Company, Franklin Lakes, NJ (US)

(72) Inventors: Barry Emerson, Sixmilebridge (IE); Niall O'Keeffe, Askeaton (IE); Sarah Daly, Clare (IE); Jamie Carroll, Tipperary (IE); Adrian Lynch, Tipperary (IE)

(21) Appl. No.: 17/830,070

(22) Filed: Jun. 1, 2022

Related U.S. Application Data
(60) Provisional application No. 63/211,997, filed on Jun. 17, 2021.

(51) Int. Cl. B01L 3/00

(52) U.S. Cl. CPC B01L 3/527; B01L 2200/16; B01L 2300/0681

(57) ABSTRACT

Reagent devices including a liquid container and a reagent insert are provided. Aspects of the reagent insert include a first dried reagent composition and a second dried reagent composition distinctly positioned on one or more surfaces of a solid support. Also provided are methods of making and using the reagent device or reagent insert, as well as systems and kits including the same.

### CROSS-REFERENCE TO RELATED APPLICATION

Pursuant to 35 U.S.C. § 119 (e), this application claims priority to the filing date of U.S. Provisional Patent Application Ser. No. 63/211,997 filed Jun. 17, 2021; the disclosure of which application is incorporated herein by reference in their entirety.

### INTRODUCTION

Assays for determining the presence and concentration of analytes in a biological sample fluid often rely on the specific binding of a detectable label to the target analyte. The detectable label may be a marker that can be visualized either by an unaided eye or detectable by spectroscopy, such as fluorescence or UV-vis spectroscopy. Typically, fluorescent dyes may be used as the detectable label, where the fluorescent dye includes a particular fluorochrome. A fluorochrome may have a certain properties, such as its absorption spectrum, its extinction coefficient at a wavelength convenient for excitation, its emission spectrum, and its quantum efficiency. Quantum efficiency is the number of photons emitted for every photon absorbed.

Multiplexed assays allow simultaneous detection of multiple analytes in a single assay. For immunoassays, multiplexed assays involve a cocktail of antibodies, each labeled with a different dye. Each antibody binds to a specific analyte or antigen in the sample. In this way, the different analytes or antigens can be differentiated based on the different dyes.

For convenience, multiplex assay reagents can be supplied as a premixed cocktail of individual binding molecules, such as antibodies. Other reaction components may be included in the cocktail, such as buffer, salt, surfactant, etc. Most convenient is a cocktail containing all necessary components (a unitary assay reagent). In this case, the assay can be performed by simply adding sample to a reaction vessel containing the cocktail.

It is convenient to provide a stable assay reagent, particularly a reagent that is stable at room temperature. This allows shipment and storage of the reagent without refrigeration. To this end, stable reagents may be provided by drying down aqueous solutions of the reagent, or by lyophilization. But a problem exists with certain fluorochromes. These fluorochromes may become cross-linked if they physically touch one another. They may remain cross-linked after resuspension in liquid solution, leading to inaccurate results that do not represent biologically relevant findings. The chemical nature of these polymeric dyes, however, prevents the storage of multiple dyes in a pooled cocktail and requires dried reagents to be physically separated prior to resuspension with specialized buffers to eliminate dye-to-dye interactions.

### SUMMARY

Reagent devices including a liquid container and a reagent insert are provided. Aspects of the reagent insert include a first dried reagent composition and a second dried reagent composition distinctly positioned on one or more surfaces of a solid support. Also provided are methods of making and using the reagent device or reagent insert, as well as systems and kits including the same.

### BRIEF DESCRIPTION OF THE FIGURES

FIGS. 1 A-B provide embodiments of a reagent insert and reagent device including a reagent insert present in a tube.

FIG. 2 provides calculations showing the expected spatial separation of eleven distinctly positioned liquid reagent compositions and a distinctly positioned liquid cocktail reagent composition on the surface of a solid support of a reagent insert in accordance with one embodiment of the invention.

FIGS. 3 A-E provides solid support geometries, according to certain embodiments of the invention.

FIGS. 4 A-B show (A) a full FACS tube containing multiple reagent inserts and (B) a first volume part of a 2-part FACS tube containing multiple reagent inserts, according to certain embodiments of the invention.

FIGS. 5 A-D show exemplary methods of making a reagent device.

### DETAILED DESCRIPTION

Reagent devices including a liquid container and a reagent insert are provided. Aspects of the reagent insert include a first dried reagent composition and a second dried reagent composition distinctly positioned on one or more surfaces of a solid support. Also provided are methods of making and using the reagent device or reagent insert, as well as systems and kits including the same.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

In further describing various embodiments of the invention, the subject reagent devices are first described in greater detail. Next, methods of making and using the reagent devices and components thereof are described, followed by a description of systems and kits including the same.

### Reagent Device

Aspects of the present disclosure include reagent devices. In certain embodiments, the reagent devices are useful in assays, for example, assays of a liquid sample, such as a biological sample, e.g., for the presence of one or more analytes in the sample. Reagent devices according to certain embodiments include a liquid container and a reagent insert present in the liquid container, the reagent insert including a first dried reagent composition and a second dried reagent composition distinctly positioned on one or more surfaces of a solid support.

The container can be any convenient container that is compatible with the liquid sample and/or reagent(s) or analyte(s) that may be in contact with the container. For example, the container can be a liquid-compatible container configured to contain a liquid sample. In some cases, the liquid sample may be an aqueous liquid sample, and in these cases, the container may be compatible with aqueous samples. By “compatible” is meant that the container (e.g., the material the container is made of) is substantially inert with respect to (e.g., does not significantly react with) the liquid and/or reagent(s) or analyte(s) in contact with the container.

The container may be configured to hold a certain volume of a fluid (e.g., gas or liquid). In certain embodiments, the container is configured as a liquid container. For example, the liquid container may be configured to hold a volume of a liquid. The size of the liquid container may depend on the volume of liquid to be held in the liquid container. For instance, the liquid container may be configured to hold a volume (e.g., a volume of a liquid) ranging from 0.1 ml to 1000 ml, such as from 0.1 ml to 900 ml, or 0.1 ml to 800 ml, or 0.1 ml to 700 ml, or 0.1 ml to 600 ml, or 0.1 ml to 500 ml, or 0.1 ml to 400 ml, or 0.1 ml to 300 ml, or 0.1 ml to 200 ml, or 0.1 ml to 100 ml, or 0.1 ml to 50 ml, or 0.1 ml to 25 ml, or 0.1 ml to 10 ml, or 0.1 ml to 5 ml, or 0.1 ml to 1 ml, or 0.1 ml to 0.5 ml. In certain instances, the liquid container is configured to hold a volume (e.g., a volume of a liquid) ranging from 0.1 ml to 200 ml, such as 0.5 ml to 100 ml, e.g., 1.0 ml to 50 ml.

The shape of the container may vary and may depend on the use of the container. For example, as described herein, the container may find use in an assay, such as an assay of a liquid sample (e.g., a biological sample). In these cases, the container may be configured in a shape that is compatible with the assay and/or the method or other devices used to perform the assay. In some embodiments, the container may be applied to blood collection. For instance, the container may be configured in a shape of typical laboratory equipment used to perform the assay or in a shape that is compatible with other devices used to perform the assay. In some instances, the container may be configured to store multiple dried dye compositions, e.g., the container may be a storage container for multiple dried dye compositions, e.g., for performance of a particular assay. As described above, the container may be configured as a liquid container. In these embodiments, the liquid container may be a vial or a test tube. In certain cases, the liquid container is a vial. In certain cases, the liquid container is a test tube. As described above, the liquid container may be configured to hold a volume (e.g., a volume of a liquid). In embodiments where the liquid container is a vial or a test tube, the liquid container may be configured to hold a volume (e.g., a volume of a liquid) ranging from 1*10\hat{ }-7 ml to 1000 ml, such as from 0.5 ml to 900 ml, or 0.5 ml to 800 ml, or 0.5 ml to 700 ml, or 0.5 ml to 600 ml, or 0.5 ml to 500 ml, or 0.5 ml to 400 ml, or 0.5 ml to 300 ml, or 0.5 ml to 200 ml, or 0.5 ml to 100 ml, or 0.5 ml to 50 ml, or 0.5 ml to 25 ml, or 0.5 ml to 10 ml, or 0.5 ml to 5 ml, or 1 ml to 5 ml. In certain instances, the vial or test tube is configured to hold a volume (e.g., a volume of a liquid) ranging from 0.5 ml to 5 ml.

As described above, embodiments of the container can be compatible with the liquid sample and/or reagent(s) or analyte(s) in contact with the container. Examples of suitable container materials include, but are not limited to, glass and plastic. For example, the container may be composed of glass, such as, but not limited to, silicate glass, borosilicate glass, sodium borosilicate glass (e.g., PYREX™), fused quartz glass, fused silica glass, and the like. Other examples of suitable container materials include plastics, such as, but not limited to, polystyrene, polypropylene, polymethylpentene, polytetrafluoroethylene (PTFE), perfluoroethers (PFE), fluorinated ethylene propylene (FEP), perfluoroalkoxy alkanes (PFA), polyethylene terephthalate (PET), polyethylene (PE), polyetheretherketone (PEEK), and the like.

In some embodiments, as described above, the container is configured to hold a certain volume of a fluid (e.g., gas or liquid). In some instances, the container is configured for holding a certain volume of a liquid (e.g., a liquid container). In some embodiments where the container is configured as a liquid container, the liquid container may be sealed. That is, the liquid container may include a seal that substantially prevents the contents of the liquid container (e.g., liquid inside the liquid container) from exiting the liquid container. The seal of the liquid container may also substantially prevent other substances from entering the liquid container. For example, the seal may be a water-tight seal that substantially prevents liquids from entering or exiting the container, or may be an air-tight seal that substantially prevents gases from entering or exiting the container. In some instances, the seal is a removable or breakable seal, such that the contents of the liquid container may be exposed to the surrounding environment when so desired, e.g., if it is desired to remove a portion of the contents of the liquid container. In some instances, the seal is made of a resilient material to provide a barrier (e.g., a water-tight and/or air-tight seal) for retaining a sample in the container. Particular types of seals include, but are not limited to, films, such as polymer films, caps, etc., depending on the type of container. Suitable materials for the seal include, for example, rubber or polymer seals, such as, but not limited to, silicone rubber, natural rubber, styrene butadiene rubber, ethylene-propylene copolymers, polychloroprene, polyacrylate, polybutadiene, polyurethane, styrene butadiene, and the like, and combinations thereof. For example, in certain embodiments, the seal is a septum pierceable by a needle, syringe, or cannula. The seal may also provide convenient access to a sample in the container, as well as a protective barrier that overlies the opening of the container. In some instances, the seal is a removable seal, such as a threaded or snap-on cap or other suitable sealing element that can be applied to the opening of the container. For instance, a threaded cap can be screwed over the opening before or after a sample has been added to the container.

As described above, the container may be configured to hold a certain volume of a fluid (e.g., gas or liquid). In some instances, the container (e.g., a liquid container) has an inner surface and an outer surface. In these embodiments, the inner surface of the container is the surface of the container (e.g., container) facing toward the inside of the container. The inner surface may be in contact with the contents of the container. As such, the container may include an inner surface of the container, such as an inner surface of a liquid container. The outer surface of the container is the surface of the container facing away from the inside of the container. The outer surface does not contact the contents of the container. As such, the container may include an outer surface of the container, such as an outer surface of a liquid container.

In other embodiments, the container includes a well of a single well or a multi-well plate. Where the container is a well of a multi-well plate, the multi-well plate may include a plurality of liquid containers (e.g., wells), such as 2 or more, or 10 or more, or 50 or more, or 75 or more, or 100 or more, or 300 or more, or 500 or more, or 750 or more, or 1000 or more or 1500 or more, or 2000 or more liquid containers (e.g., wells). Examples of containers configured as multi-well plates may include, for example, 6, 12, 24, 48, 96, 384 or 1536 liquid containers (e.g., wells). In embodiments where the liquid container is a well of a multi-well plate, an individual well may be configured to hold a volume (e.g., a volume of a liquid) ranging from 0.1 ml to 1000 ml, such as from 0.1 ml to 900 ml, or 0.1 ml to 800 ml, or 0.1 ml to 700 ml, or 0.1 ml to 600 ml, or 0.1 ml to 500 ml, or 0.1 ml to 400 ml, or 0.1 ml to 300 ml, or 0.1 ml to 200 ml, or 0.1 ml to 100 ml, or 0.1 ml to 50 ml, or 0.1 ml to 25 ml, or 0.1 ml to 10 ml, or 0.1 ml to 5 ml, or 0.1 ml to 1 ml, or 0.1 ml to 0.5 ml. In certain instances, the vial or test tube is configured to hold a volume (e.g., a volume of a liquid) ranging from 0.1 ml to 25 ml.

A container of the invention may also be configured as a bottle, canister or analogous structure, e.g., configured to hold multiple dried reagent compositions. In such instances the bottle, canister or analogous structure may have a volume ranging from ranging from 0.1 ml to 1000 ml, such as from 0.1 ml to 900 ml, or 0.1 ml to 800 ml, or 0.1 ml to 700 ml, or 0.1 ml to 600 ml, or 0.1 ml to 500 ml, or 0.1 ml to 400 ml, or 0.1 ml to 300 ml, or 0.1 ml to 200 ml, or 0.1 ml to 100 ml, or 0.1 ml to 50 ml, or 0.1 ml to 25 ml, or 0.1 ml to 10 ml, or 0.1 ml to 5 ml, or 0.1 ml to 1 ml, or 0.1 ml to 0.5 ml. In certain instances, the vial or test tube is configured to hold a volume (e.g., a volume of a liquid) ranging from 0.1 ml to 25 ml.

The container, e.g., fully assembled container, may include separate portions that are coupled, e.g., joined or attached, to one another. In some instances, the container includes a container bottom portion (e.g., a bottom portion defining a first volume) and a container wall portion that are attached together to form the container. The container bottom portion and container wall portion may be attached in a manner such that when the fully assembled container is held upright, the container bottom portion forms the closed bottom end of the container and the container wall portion forms container walls rising from the container bottom portion. The container wall portion of the container may form an opening for receiving a sample, where the opening is present at an end of the container that is opposite from the closed bottom end of the container. Suitable containers include those that are described in, e.g., U.S. Provisional Application No. 63/144,185, the disclosure of which is incorporated by reference herein in its entirety.

The container bottom portion and the container wall portion may be attached by any suitable means. In some instances, the container bottom portion and the container wall portion are permanently (i.e., irreversibly) attached to each other. In some instances, the container wall portion and the container bottom portion are press fitted, snap fitted, or screwed together. In some instances, the container wall portion and the container bottom portion are solvent bonded, adhesive bonded (e.g., glue adhesive bonded), or welded (e.g., friction welded or ultrasonically welded) to each other.

The container wall portion may be attached to the container bottom portion at a sealed attachment region joining the container bottom portion to the container wall portion. The sealed attachment region may include an attachment or joining region between the bottom and wall portions, which is configured to prevent passage of a fluid, e.g., a liquid, from the interior to the exterior of the container. That is, the sealed attachment region may substantially prevent, if not complete inhibit, the contents of the container (e.g., liquid inside the liquid container) from exiting the container at the liquid seal attachment region (such that it may be referred to as a liquid seal attachment region, since it is an attachment region that serves as a seal to prevent the passage of liquid). For example, the sealed attachment region may include a watertight seal at the interface between the container bottom portion and the container wall portion. The sealed attachment region may include a connection line indicating an interface between the container bottom portion and the container wall portion. In some embodiments, a seal or gasket may be used in the sealed attachment region. For example, the connection line may indicate where the container bottom portion and the container wall portion meet and attach to one another. In some instances, the connection line extends around or across the perimeter of a cross-section of the container. In some instances, the connection line extends around or across a portion of the perimeter of a cross-section of the container. The connection line may have any suitable combination of straight and curved lines. In some instances, the connection line is a straight line.

The bottom portion may include a closed end and a wall rising therefrom. The container bottom portion may have an inner surface and an outer surface. The inner surface of the container bottom portion may be the surface of the container bottom portion facing toward the inside of the container bottom portion. The inner surface may be in contact with the contents of the container once the container is assembled. One or more dried reagent compositions, as described below, may be positioned on the inner surface of the container bottom portion. The outer surface of the container bottom portion is the surface of the container bottom portion facing away from the inside of the container bottom portion. The outer surface does not contact the contents of the container once the container is assembled. In some embodiments, a coating may be applied to the internal surface to alter material properties, improve dispense adhesion and/or separation. Any convenient type of coating capable of imparting such functional may be employed, as desired. In some instances, the container bottom portion includes the bottom closed end of a tube or vial including, e.g., a rounded closed end of a tube or vial. The closed end and wall rising therefrom may have any suitable cross-sectional shape including, e.g., rectilinear cross sectional shapes, e.g., squares, rectangles, trapezoids, triangles, hexagons, etc., curvilinear cross-sectional shapes, e.g., circles, ovals, as well as irregular shapes, e.g., a parabolic shape.

The container bottom portion may have any suitable dimensions. In some such as 0.1 to 3 cm and including 1.1 to 2 cm. In some instances, the container bottom portion has a width, e.g., diameter, ranging from 0.1 to 15 cm, such as 0.1 to 3 cm and including 1.0 to 2 cm. In some instances, the first volume defined by the container bottom portion ranges from 0.01 to 1000 ml, such as 0.01 to 50 ml and including 0.1 to 0.6 ml.

The container wall portion may include an elongated member having a wall that is joined at one end to the container bottom portion, such as described above, and an open top end distal to the container bottom portion. In some instances, the container wall portion is configured as a neck of a tube or vial. The elongated member may have any suitable cross-sectional shape including, e.g., rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic shape. The container wall portion may have any suitable dimensions. In some instances, the container wall portion has a height (i.e., dimension running the length of the elongated member from the end that is joined to the container bottom portion to the open top end) ranging from 0.5 to 100 cm, such as 0.5 to 15 cm and including 3 to 8. In some instances, the container wall portion has a width, e.g., diameter, ranging from 0.1 to 15 cm, such as 0.1 to 3 cm and including 1.0 to 2 cm, where in some instances the container wall portion has width dimensions that match the width dimensions of the container bottom portion. In some instances, the container wall portion defines a volume ranging from 0.5 to 1000 ml, such as 0.5 to 20 ml and including 3 to 8 ml.

In some instances, the liquid container includes a dried reagent composition positioned on an inner surface thereof. In some instances, the liquid container includes a container bottom portion as described above and a dried reagent composition positioned on an inner surface of the container bottom portion. Dried reagent compositions may be positioned on an inner surface of a container in any suitable manner, e.g., as described in U.S. Pat. No. 10,545,137 and U.S. Provisional Application No. 63/144,185, the disclosures of which are incorporated herein by reference in their entirety.

As summarized above, a reagent insert may be present in the liquid container, e.g., positioned inside the liquid container. The reagent insert may include a solid support and one or more dried reagent compositions positioned on one or more surfaces of the solid support. As used herein, the term “solid support” can refer to a discrete solid or substrate on which one or more dried reagent compositions may be positioned, e.g., adhered. The reagent insert may be positioned at any suitable position in or location of the liquid container, e.g., in the neck or bottom of the container. In some instances, the reagent insert is present inside a container bottom portion. A liquid container may contain a plurality of reagent inserts including, e.g., two or more, three or more, four or more, five or more, six or more, seven or more, eight or more, nine or more, or ten or more reagent inserts. In some instances, the reagent inserts in the container are identical. In some instances, the container includes at least two different reagent inserts. The reagent inserts may differ by one or more of the types of solid support (e.g., material, shape, dimensions, etc.), the number of dried reagent compositions positioned on the solid supports, the locations of the dried reagent compositions positioned on the solid supports, and the composition (e.g., reagents, dye composition, formulation, etc.) of the dried reagent compositions positioned on the solid supports.

In some instances, the solid support of the reagent insert is not stably associated with any surface of the container, such as any interior wall location of the container. In these instances, as the solid support is not stably associated with any surface of the container, it moves freely relative the surfaces of the container. In such instances, the solid support is not bound in any way to a surface of the container. In some embodiments, the reagent insert, e.g., solid support, is removable from the liquid container.

In certain embodiments, the solid support is stably associated with the liquid container, e.g., an inner surface of the liquid container. In such embodiments, the stably associated solid support does not move from the location where it is positioned in the container. In certain embodiments, the solid support is stably associated with an inner surface of the liquid container by friction contact between the solid support and the inner surface. In such embodiments, friction between the solid support and the liquid container prevents movement of the solid support. In certain embodiments, the solid support is stably associated with an inner surface of the liquid container by compression of one or more edges of the solid support against the inner surface. The edge(s) of the solid support may be flexible such that the edge(s) bend when pressed against the inner surface. The edge(s) may act like compressed springs against the inner surface of a container to keep the reagent insert in place. In certain embodiments, the solid support is attached, e.g., adhered to the container, e.g., an inner surface of the container. In some instances, the solid support includes a substance that stably associates, e.g., attaches, the solid support with an inner surface of the liquid container. Suitable substances include, e.g., an adhesive, an elastomer, mechanical feature and/or mechanical fixing. In some instances, the solid support includes a rubber edge. In some embodiments, the reagent insert, e.g., solid support, is removable, e.g., detachable, from the liquid container.

The dimensions of the solid support may vary, as desired, where in some instances the dimensions are determined with respect to the dimensions of the container into which the support is to be placed. The solid support may include any suitable number of surfaces. In some instances, the solid support has two or more surfaces including, e.g., three or more, four or more, five or more, or six or more surfaces. Each of the two or more surfaces may have the same surface area or different surface areas. In some instances, the solid support has a surface having a surface area ranging from 10 mm² to 600 mm². In some instances, the solid support has two or more surfaces, where the surface area of the surfaces ranges from 10 mm² to 6000 mm², such as from 50 mm² to 300 mm². In some instances, the surface(s) of the solid support have a surface area of 50 mm² or more, such as 100 mm² or more, including 75 mm² or more, e.g., as determined using a Vertex system or equivalent. The solid support may include one or more flat surfaces and/or one or more curved surfaces. In some instances, the solid support includes a flat surface. In some instances, the solid support includes a curved surface. The solid support may have any suitable height. In some instances, the solid support has a height ranging from 0.1 mm to 500 mm. The solid support may have any suitable cross-sectional width or diameter. In some instances, the cross-sectional width or diameter of the solid support is equivalent to that of the inner volume of the liquid container. In some instances, a horizontal cross-section of the solid support has a width ranging from 0.1 mm to 100 mm. In some instances, the solid support has a longest dimension ranging from 0.1 mm to 100 mm, such as from 2 mm to 5 mm. The shapes of the solids support may also vary as desired. In some instances, the solid support may be shaped or configured as discs, spheres, ovates, cubes, blocks, cones, etc., as well as irregular shapes. Suitable cross-sectional shapes include, e.g., circular, triangular, rectangular, irregular, etc. The mass of the solid supports may vary, ranging in some instances from 1 mg to 50000 mg including, e.g., from 100 mg to 1000 mg.

The solid supports may be fabricated from any convenient material. In some instances, the solid support is fabricated from a material that is the same material from which the liquid container is fabricated. In certain embodiments, the solid support is fabricated from an inert material. In some instances, the solid support includes a flexible material. In some instances, the solid support includes a rigid material. Suitable materials include, but are not limited to, glass materials (e.g., silicates), ceramic materials (e.g., calcium phosphates), metallic materials (e.g., metals) such as for example stainless steel, and polymeric materials (e.g., plastic), etc. such as for example, polyethylene, polypropylene, polytetrafluoroethylene, polyvinylidine fluoride, and the like.

In certain embodiments, a surface of the solid support includes a coating that modulates a contact angle, e.g., a water contact angle, of the surface. As used herein, the term “contact angle” refers to the angle, measured through the liquid, where a liquid/vapor interface meets a solid surface. The contact angle is used to quantify the wettability of a solid surface by a liquid via the Young equation. For example, when water is the liquid, the term “hydrophobic” may be applied to surfaces which give a contact angle of 90 degrees or greater. The term “hydrophilic” may be applied to surfaces which give a contact angle of less than 90 degrees. It is understood that the degree of hydrophobicity or hydrophilicity of a surface may vary with the water contact angle. The term “superhydrophobic” is applied to surfaces which give contact angles at least 150 degrees with water. For a perfectly hydrophobic surface the contact angle should be 180 degrees. In certain embodiments, the coating provides a water contact angle of 60 degrees to 110 degrees, including, e.g., 75 degrees to 90 degrees. Suitable coatings/surface treatments include, but are not limited to, etching, plasma treating and PTFE coating.

The reagent insert may include a material or be configured in a manner that allows or does not allow liquid to pass through the solid support. In some embodiments, the solid support is configured to prevent liquid from passing through the solid support. In some instances, the solid support is fabricated from an impermeable material. In some instances, the solid support lacks liquid passageways, e.g., openings. In some embodiments, the solid support is configured as a plug. In some embodiments, the solid support is configured to allow liquid to pass through the solid support. In such embodiments, the solid support may include one or more liquid passageways, e.g., openings or holes. In some instances, the solid support is configured to allow a pipette or sample tip to pass through the solid support. For example, the solid support may include one or more openings of a size that allows a pipette or sample tip to pass through the opening(s). In some instances, the solid support is configured as a retainer. Any convenient retainer may be employed. In some instances, the retainer includes a filter. Filter structures that may be employed may vary, where in some instances the filter is a planar structure, e.g., a membrane, having a desired porosity, such as described herein. In general, the filter may be a structure configured to selectively allow passage of certain components of a liquid but prevent passage of other components of a liquid. In some instances, the filter is configured to allow passage of dissolved substances and single cells of a liquid, but impede, and in some instances prevent, passage of other components of a liquid, such as cellular aggregates, tissues, etc. In some instances, the filter is configured to allow passage of single cells having a volume of 2000 fl or less, such as 1500 fl or less, including 1200 fl or less. In some instances, the filter is configured to impede, and in some instances prevent, passage of a structures having a volume of 2500 fl or greater, such as 5000 fl or greater. In some instances, the filter is a mesh (i.e., a material made of a network of wire or thread), where the mesh size may vary, ranging in some instances from 0.5 mm to 5 mm. Pores, i.e., openings or holes, of the filter, e.g., mesh, may vary in size, ranging in some instances from 10 to 300 μm, such as 20 to 150 μm, including 30 to 100 μm, including 20, 35, 40, 70 and 100 μm. The retainer may be fabricated from any suitable material, where materials of interest include, but are not limited to: glass materials (e.g., silicates), ceramic materials (e.g., calcium phosphates), metallic materials, and polymeric materials, etc. such as for example, polyethylene, polypropylene, polytetrafluoroethylene, polyvinylidene fluoride, and the like.

As summarized above, one or more dried reagent compositions (e.g., dried dye compositions) may be positioned on, e.g., stably associated with, one or more surfaces of a solid support of the reagent insert. As such, the reagent insert may include at least a first dried reagent composition stably associated with a solid support. The total number of dried reagent compositions may vary as desired. The reagent insert may include one or more dried reagent compositions (e.g., dye compositions) positioned on one or more surfaces, such as 2 or more dried reagent compositions, or 3 or more, or 4 or more, or 5 or more, or 6 or more, or 7 or more, or 8 or more, or 9 or more, or 10 or more, or 11 or more, or 12 or more, or 13 or more, or 14 or more, or 15 or more, 16 or more, or 17 or more, or 18 or more, or 19 or more, or 20 or more, or 25 or more, or 30 or more, or 35 or more, or 40 or more, or 45 or more, or 50 or more dried reagent compositions positioned on one or more surfaces of the solid support. In some embodiments, the reagent insert includes 2 to 50 dried reagent compositions on one or more surfaces of the solid support, such as 2 to 40, or 2 to 30 or 2 to 20 or 2 to 15, or 2 to 10, or 2 to 7, or 2 to 5 dried reagent compositions on one or more surfaces of the solid support. For example, the reagent insert may include 2, or 3, or 4, or 5, or 6, or 7, or 8, or 9, or 10, or 11, or 12, or 13, or 14, or 15, or 16, or 17, or 18, or 19, or 20 dried reagent compositions on one or more surfaces of the solid support. In certain cases, the reagent insert includes 2 dried reagent compositions on one or more surfaces of the solid support. In certain cases, the reagent insert includes 5 dried reagent compositions on one or more surfaces of the solid support. In certain cases, the reagent insert includes 7 dried reagent compositions on one or more surfaces of the solid support. In certain cases, the reagent insert includes 10 dried reagent compositions on one or more surfaces of the solid support. In certain cases, the reagent insert includes 15 dried reagent compositions on one or more surfaces of the solid support. In some instances, the reagent insert includes a first dried reagent composition and a second dried reagent composition distinctly positioned on one or more surfaces of a solid support.

The dried reagent compositions may include any desired reagent or reagents, such that a given dried reagent composition may include a single reagent or two or more distinct reagents. Reagents of interest include, but are not limited to, dyes, nucleic acids, nucleotides, proteins, peptides, polysaccharides, etc. In some instances, the dried reagent compositions are dye compositions, e.g., as described in greater detail below.

In a given container, the dried reagent compositions may be identical or at least two of the dried reagent compositions in the container may be distinct from each other. In certain cases, the reagent device includes 2 distinct dried reagent compositions. In certain cases, the reagent device includes 5 distinct dried reagent compositions. In certain cases, the reagent device includes 7 distinct dried reagent compositions. In certain cases, the reagent device includes 10 distinct dried reagent compositions. Any two dried reagent compositions are considered to be distinct if their components, e.g., dye components, differ from each other by one or more of molecular formula, excitation maximum and emission maximum. As such, different or distinct dried reagent compositions, e.g., dye compositions, may differ from each other in terms of chemical composition and/or in terms of one or more properties of the dried reagent compositions, e.g., dyes. For instance, different dye compositions may differ from each other by at least one of excitation maxima and emission maxima. In some cases, different dye compositions differ from each other by their excitation maxima. In some cases, different dye compositions differ from each other by their emission maxima. In some cases, different dye compositions differ from each other by both their excitation maxima and emission maxima. As such, in embodiments that include first and second dyes, the first and second dyes may differ from each other by at least one of excitation maxima and emission maxima. For example, the first and second dyes may differ from each other by excitation maxima, by emission maxima, or by both excitation and emission maxima. Additional dye compositions may be included in the reagent device, where each of the dye compositions in the reagent device differ from each other as described above. A given pair of dyes may be considered distinct if they differ from each other in terms of excitation or emission maximum, where the magnitude of such difference is, in some instances, 5 nm or more, such 10 nm or more, including 15 nm or more, wherein in some instances the magnitude of the difference ranges from 5 to 400 nm, such as 10 to 200 nm, including 15 to 100 nm, such as 25 to 50 nm.

As described above, the container may include two or more dried reagent compositions positioned relative to one or more surfaces of the solid support. In some instances, the first and second, e.g., two or more, dried reagent compositions are adhered to one or more surfaces of the solid support. By adhered is meant that the dried reagent compositions are stably associated with the location of the surface where they are positioned, such that they do not move from the location of the surface where they are positioned when in the dry state. Upon reconstitution, the reagents, e.g., dyes, of the dried reagent compositions are dissociated from the surface location where they are positioned, such that they are present in the liquid that was employed to reconstitute the dried reagent compositions, e.g., are in solution in the liquid, such as an aqueous liquid. The dried reagent compositions may be located on the one or more surfaces of the solid support in distinct positions. For example, first and second dried reagent compositions may be distinctly positioned on the one or more surfaces of the solid support. By “distinct position” or “distinctly positioned” or “spatially separated” is meant that a dried reagent composition is disposed at a position different from the position of another dried reagent composition. The position of a dried reagent composition may refer to the location of the dried reagent composition on the surface of the solid support, and/or may refer to the position of the dried reagent composition relative to the surface of the solid support. In some cases, a dried reagent composition occupies a defined volume of space. For example, a dried reagent composition may occupy a volume of space on a surface of the solid support. A distinctly positioned dried reagent composition may occupy a volume of space that does not significantly coincide or overlap with a volume of space occupied by another dried reagent composition, where in some instances it does not coincide or overlap at all with a volume of space occupied by another dried reagent composition. Embodiments where dried reagent compositions are distinctly positioned may provide for a minimization in interactions, e.g., dye-dye interactions, between each of the dried reagent compositions.

Stated another way, a distinctly positioned dried reagent composition is not significantly mixed together with another dried reagent composition (e.g., polymeric dye composition), e.g., substantially no portion of the distinctly positioned dried reagent composition is mixed with a portion of another dried reagent composition (e.g., polymeric dye composition). In some instances, a distinctly positioned dried reagent composition is not mixed together with another dried reagent composition (e.g., polymeric dye composition), e.g., no portion of the distinctly positioned dried reagent composition is mixed with a portion of another dried reagent composition (e.g., polymeric dye composition). In certain embodiments, a distinctly positioned dried reagent composition includes a single reagent. For example, a distinctly positioned dried reagent composition may be substantially composed of a single reagent and does not include another reagent in a significant amount. A distinctly positioned dried reagent composition may include a large excess of a reagent with respect to any other reagent that may be in the dried reagent composition, such as, for example, 75 wt % or more, such as 80 wt % or more, or 85 wt % or more, or 90 wt % or more, or 95 wt % or more, or 97 wt % or more or 99 wt % or more, or 100 wt % of a reagent with respect to any other reagent that may be in the dried reagent composition. In certain embodiments, a distinctly positioned dried reagent composition includes a single dye. For example, a distinctly positioned dried reagent composition may be substantially composed of a single dye and does not include another dye in a significant amount. A distinctly positioned dried reagent composition may include a large excess of a dye with respect to any other dye that may be in the dried reagent composition, such as, for example, 75 wt % or more, such as 80 wt % or more, or 85 wt % or more, or 90 wt % or more, or 95 wt % or more, or 97 wt % or more or 99 wt % or more, or 100 wt % of a dye with respect to any other dye that may be in the dried reagent composition.

In some instances, the dried reagent composition(s) include two or more reagents (e.g., distinct reagents). In some instances, the first and/or second dried reagent composition includes two or more reagents including, e.g., three or more reagents, four or more reagents, five or more reagents, six or more reagents, seven or more reagents, eight or more reagents, nine or more reagents, or ten or more reagents, e.g., 15 or more reagents, such as 20 or more reagents, e.g., 25 or more reagents. In some instances, where a given dried reagent composition includes a plurality, e.g., two or more, three or more, including four or more, etc., distinct reagents, it may be referred to as a dried cocktail reagent composition. In some instances, the dried reagent composition(s) include two or more dyes. In some instances, the first and/or second dried reagent composition includes two or more dyes including, e.g., three or more dyes, four or more dyes, five or more dyes, six or more dyes, seven or more dyes, eight or more dyes, nine or more dyes, or ten or more dyes. Where a given dried reagent composition includes a plurality, e.g., two or more, such as three or more, including four or more, etc., distinct dyes, it may be referred to as a dried dye cocktail reagent composition. In some instances, the dried dye cocktail reagent composition includes two or more distinct non-polymeric dyes. In certain embodiments, the mixture of the non-polymeric dyes in the dried cocktail reagent composition does not undergo significant dye-dye interactions. For instance, the fluorescence emission energy of each of the non-polymeric dyes is not significantly quenched by interactions with other non-polymeric dyes in the same mixture. In some cases, the fluorescence emission energy of each of the non-polymeric dyes is not significantly dissipated by a non-radiative transition. In these embodiments, the detectable fluorescence of the non-polymeric dyes is not significantly less than would be expected as compared to the fluorescence of the non-polymeric dyes in the absence of the other non-polymeric dyes. In some instances, the dried dye cocktail reagent composition includes one polymeric dye, where the polymeric dye does not have dye-dye interactions with the non-polymeric dye(s). The dried dye cocktail reagent composition may be distinctly positioned on a surface of the solid support, e.g., relative to other dried reagent compositions positioned on the surface(s) of the solid support.

In some instances, distinctly positioned dried reagent compositions are spaced apart from each other at separate locations on one or more surfaces of the solid support. A dried reagent composition that is spaced apart from another dried reagent composition may be physically separated from adjacent dried reagent compositions. For instance, distinctly positioned dried reagent compositions may be positioned on one or more surfaces of the solid support at separate locations such that there is a certain distance between an edge of the dried reagent composition and an edge of an adjacent dried reagent composition. In some embodiments, the distance between the separate locations of the dried reagent compositions on the surface(s) of the solid support is 0.1 mm or more, such as 0.5 mm or more, or 1 mm or more, or 2 mm or more, or 3 mm or more, or 4 mm or more, or 5 mm or more, or 6 mm or more, or 7 mm or more, or 8 mm or more, or 9 mm or more, or 10 mm or more, or 12 mm or more, or 14 mm or more, or 16 mm or more, or 18 mm or more, or 20 mm or more, or 25 mm or more or 30 mm or more, or 35 mm or more, or 40 mm or more, or 50 mm or more, or 60 mm or more, or 70 mm or more, or 80 mm or more, or 90 mm or more, or 100 mm or more, or 110 mm or more, or 120 mm or more, or 130 mm or more, or 140 mm or more, or 150 mm or more, or 160 mm or more, or 170 mm, or more, or 180 mm or more, or 190 mm or more, or 200 mm or more. For example, the distance between the separate locations of the dried reagent compositions on the surface(s) of the solid support may range from 0.1 mm to 200 mm, such as from 0.1 mm to 190 mm, or 0.1 mm to 180 mm, or 0.1 mm to 170 mm, or 0.1 mm to 160 mm, or 0.1 mm to 150 mm, or 0.1 mm to 140 mm, or 0.1 mm to 130 mm, or 0.1 mm to 120 mm, or 0.1 mm to 110 mm, or 0.1 mm to 100 mm, or 0.1 mm to 90 mm, or 0.1 mm to 80 mm, or 0.1 mm to 70 mm, or 0.1 mm to 60 mm, or 0.1 mm to 50 mm, or 0.1 mm to 40 mm, or 0.1 mm to 30 mm, or 0.1 mm to 20 mm, or 0.1 mm to 10 mm, or 0.1 mm to 9 mm, or 0.1 mm to 8 mm, or 0.1 mm to 7 mm, or 0.1 mm to 6 mm, or 0.1 mm to 5 mm, or 0.1 mm to 4 mm, or 0.1 mm to 3 mm, or 0.1 mm to 2 mm, or 0.1 mm to 1 mm, or 0.1 mm to 0.5 mm. In certain instances, the distance between the separate locations of the dried reagent compositions on the surface(s) of the solid support ranges from 0.1 mm to 200 mm. In some cases, the distance between the separate locations of the dried reagent compositions on the surface(s) of the solid support ranges from 0.1 mm to 10 mm.

In certain embodiments, distinctly positioned dried reagent compositions are positioned adjacent to each other on the one or more surfaces of the solid support, but are not spaced apart from each other. In these instances, an edge of a dried reagent composition may contact the edge of an adjacent dried reagent composition. For example, the volume of space occupied by a dried reagent composition may contact, but not significantly overlap with a volume of space occupied by another (adjacent) dried reagent composition. In these embodiments, adjacent dried reagent compositions may contact each other, but are not significantly mixed together, e.g., substantially no portion of the distinctly positioned dried reagent composition is mixed with a portion of another (adjacent) dried reagent composition.

The distinctly positioned dried reagent compositions may be positioned on any suitable surface(s) of the solid support. In some instances, first and second dried reagent compositions are distinctly positioned on a surface of the solid support, e.g., the same surface of the solid support. For example, the distinctly positioned dried reagent compositions may be present on the same surface of the solid support but may be disposed at different positions on or relative to the surface of the solid support. In some instances, the first and second dried reagent compositions are positioned at separate locations on a surface of the solid support. The first and second dried reagent compositions may be separated by a distance including any of the distances as described herein. In certain embodiments, the first and second dried reagent compositions are co-located at the same location of the surface of the solid support. In such instances, the first and second dried reagent compositions may be separated from each other by a non-dye material. In some instances, the distinctly positioned dried reagent compositions are positioned on different surfaces of the solid support. In some instances, one or more dried reagent compositions are distinctly positioned on a first surface of the solid support and one or more additional dried reagent compositions are distinctly positioned on additional surfaces of the solid support, e.g., a second surface, third surface, fourth surface, etc. For example, a first dried reagent composition may be positioned on a first surface of the solid support and a second dried reagent composition may be positioned on a second surface of the solid support.

Examples of distinctly positioned dried reagent compositions include embodiments where a dried reagent composition is disposed on a surface of a solid support at a certain location and another dried reagent composition is also disposed on a surface of the solid support at a different location. As such, the distinctly positioned dried reagent compositions may be positioned at separate locations on a surface of the solid support. For example, embodiments of the reagent inserts may include first and second dried reagent compositions, where the first dried reagent composition is positioned at a certain location on a surface of the solid support and the second dried reagent composition is positioned on the same surface of the solid support at a different location than the first dried reagent composition. As described above, the first and second dried reagent compositions may be spaced apart from each other such that there is a distance between the separate locations of the first and second dried reagent compositions on the surface of the solid support. The distance between the first and second dried reagent compositions may be according to the ranges and values as described above. In some embodiments, the distinctly positioned dried reagent compositions may be positioned at separate locations where the separate locations are on two or more different surfaces of the solid support. For example, embodiments of the reagent inserts may include first and second dried reagent compositions, where the first dried reagent composition is positioned at a certain location on a surface of the solid support and the second dried reagent composition is positioned on a different surface of the solid support, i.e., at a location on a surface that is different from the surface on which the first dried reagent composition is positioned. As described above, the first and second dried reagent compositions may be spaced apart from each other, e.g., on different surfaces, such that there is a distance between the separate locations of the first and second dried reagent compositions on the surfaces of the solid support. The distance between the first and second dried reagent compositions may be according to the ranges and values as described above.

The dried reagent composition(s) may have any suitable dimensions. In some instances, the first and second dried reagent compositions have the same dimensions. In certain embodiments, the first and second dried reagent compositions include different dimensions. The dried reagent compositions may have any suitable cross-sectional shape including, e.g., rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic shape. In some instances, the first and second dried reagent compositions have a diameter ranging from 0.01 mm to 5 mm including, e.g., from 0.01 mm to 4 mm, from 0.01 mm to 3 mm, from 0.01 to 2 mm, from 0.01 to 1 mm, from 0.1 mm to 5 mm, from 0.1 mm to 4 mm, from 0.1 mm to 3 mm, from 0.1 to 2 mm, from 0.1 to 1 mm, from 0.5 mm to 5 mm, from 0.5 mm to 4 mm, from 0.5 mm to 3 mm, from 0.5 to 2 mm, from 0.5 to 1 mm. In some instances, the first and second dried reagent compositions include a surface area ranging from 5×10⁻⁵ mm² to 20 mm² including, e.g., 5×10⁻⁵ mm² to 20 mm², 5×10⁻³ mm² to 20 mm², 0.1 mm² to 20 mm², 5×10⁻⁵ mm² to 0.5 mm², 5×10⁻³ mm² to 0.5 mm², 0.1 mm² to 0.5 mm².

Additional dried reagent compositions may be provided on the surface(s) of the solid support. For example, the reagent insert may include a third dried reagent composition (e.g., dye composition) distinctly positioned on a surface of the solid support. The third dried reagent composition may be distinctly positioned relative to the first dried reagent composition, and also may be distinctly positioned relative to the second dried reagent composition. As such, each of the dried reagent compositions (e.g., first, second and third dried reagent compositions) may be distinctly positioned relative to each other on the surface(s) of the solid support, as described herein. Additional distinctly positioned dried reagent compositions may be provided on the surface(s) of the solid support, such as 4 or more distinctly positioned dried reagent compositions, or 5 or more, 7 or more, 10 or more, etc., as described above. In some instances, the dried reagent compositions are adhered to the surface(s) of the solid support.

Additional examples of distinctly positioned dried reagent compositions include embodiments where a dried reagent composition is disposed on a surface of a solid support at a certain location and another dried reagent composition is located at the same location. As such, the distinctly positioned dried reagent compositions may be co-located at the same location of the surface of the solid support. Dried reagent compositions may be co-located at the same location yet still be distinctly positioned. For example, dried reagent compositions may be separated from each other by a non-dye material. In some cases, the non-dye material is interposed between distinctly positioned dried reagent compositions. The non-dye material may substantially cover a surface of a dried reagent composition such that an adjacent dried reagent composition is separated from the dried reagent composition. For instance, a dried reagent composition may have a non-dye material disposed over the surface of the dried reagent composition, and another dried reagent composition may be disposed on a surface of the non-dye material. In these instances, the dried reagent composition may be physically separated from other dried reagent compositions by the non-dye material. In some cases, the distinctly positioned dried reagent compositions may be provided as alternating layers of a dried reagent composition and a non-dye material on a surface of the solid support. As such, in certain embodiments, two or more dried reagent compositions are distinctly positioned relative to each other and are also co-located at the same location of the surface of the solid support.

In certain embodiments, the non-dye material is a material compatible with other assay components (e.g., reagents, buffers, analytes, etc.) that may be present in the container during use. The non-dye material may be substantially inert with respect to the other assay components (e.g., reagents, buffers, analytes, etc.) that may be present in the container during use such that there is no significant reaction between the non-dye material and the other assay components. Examples of non-dye materials include, but are not limited to, stabilizers, buffers, soluble inert materials (e.g., aqueous soluble inert materials), and the like. Stabilizers of interest include, but are not limited to: sugars and polyalcohols. Sugars and polyalcohols suitable for use in lyophilized dye compositions include sugars that are compatible with the other reagents, buffers, dyes and sample components being used. Examples of suitable sugars include, but are not limited to, sucrose, maltose, trehalose, 2-hydroxypropyl-beta-cyclodextrin (β-HPCD), lactose, glucose, fructose, galactose, glucosamine, and the like, and combinations thereof. In certain instances, the sugar is a disaccharide. For example, the disaccharide may be sucrose. Examples of suitable polyalcohols include, but are not limited to, mannitol, glycerol, erythritol, threitol, xylitol, sorbitol, and the like, and combinations thereof. Non-dye materials may include, for example, bovine serum albumin (BSA), sodium azide, glycerol, phenylmethanesulfonyl fluoride (PMSF), ethylenediaminetetraacetic acid (EDTA), buffered citrate, phosphate buffered saline (PBS), sodium chloride, paraformaldehyde, and the like, and combinations thereof.

For example, embodiments of the containers may include first and second dried reagent compositions, where the first dried reagent composition is positioned at a certain location on the surface of the solid support and the second dried reagent composition is co-located at the same location as the first dried reagent composition. As described above, the first and second dried reagent compositions may be spaced apart from each other such that there is a distance between the first and second dried reagent compositions. For instance, the first and second dried reagent compositions may be separated from each other by a non-dye material, as described above. The distance between the first and second dried reagent compositions may be according to the ranges and values as described above. For example, the non-dye material may be interposed between the distinctly positioned first and second dried reagent compositions. In these embodiments, the first dried reagent composition may be positioned on a surface of the solid support, the non-dye material may be disposed as a layer on a surface of the first dried reagent composition, and the second dried reagent composition may be disposed on the surface of the non-dye composition. In these instances, the first dried reagent composition may be physically separated from the second dried reagent compositions by the non-dye material. As such, in certain embodiments, the first and second dried reagent compositions are distinctly positioned relative to each other and are also co-located at the same location of the surface of the solid support. For example, the layer of non-dye material on the surface of the first dried reagent composition may substantially cover the entire surface of the first dried reagent composition. In these instances, a second dried reagent composition disposed on the surface of the non-dye composition may not significantly contact the first dried reagent composition. In some cases, the non-dye material is a substantially contiguous layer of non-dye material on the surface of the first dried reagent composition. For example, the non-dye material may cover a substantial portion of the surface of the first dried reagent composition, such as 75% or more of the surface of the first dried reagent composition, or 80% or more, or 85% or more, or 90% or more, or 95% or more, or 97% or more, or 99% or more of the surface of the first dried reagent composition. Embodiments where the surface of the first dried reagent composition is substantially covered by the non-dye material may provide for a minimization in dye-dye interactions between the first and second dried reagent compositions.

In certain embodiments, the non-dye material has a thickness ranging from 0.01 mm to 5 mm, such as from 0.05 mm to 5 mm, or 0.1 mm to 5 mm, or 0.1 mm to 4 mm, or 0.1 mm to 3 mm, or 0.1 mm to 2 mm, or 0.1 mm to 1 mm, or 0.1 mm to 0.9 mm, or 0.1 mm to 0.8 mm, or 0.1 mm to 0.7 mm, or 0.1 mm to 0.6 mm, or 0.1 mm to 0.5 mm. In certain instances, the non-dye material has a thickness from 0.1 mm to 1 mm. In some cases, the non-dye material has a thickness from 0.1 mm to 0.05 mm.

Additional dried reagent compositions may also be provided. For example, the container may include a third dried reagent composition distinctly positioned relative to the first and second dried reagent compositions. As such, the third dried reagent composition may be distinctly positioned relative to the first dried reagent composition, and also may be distinctly positioned relative to the second dried reagent composition. Thus, each of the dried reagent compositions (e.g., first, second and third dried reagent compositions) may be distinctly positioned relative to each other, as described herein. In some cases, each of the dried reagent compositions may be separated from each other by a non-dye material. For instance, each of the dried reagent compositions may be separated from each other by a non-dye material. In some cases, the non-dye material is interposed between each of the distinctly positioned dried reagent compositions. In certain instances, each of the distinctly positioned dried reagent compositions is provided as a layer with a layer of the non-dye material in between each of the distinctly positioned dried reagent compositions. Additional layers of distinctly positioned dried reagent compositions may be provided, such as 4 or more distinctly positioned dried reagent compositions, or 5 or more, 7 or more, 10 or more, etc., as described above. As such, a plurality of dried reagent compositions can be distinctly positioned relative to each other and also co-located at the same location of the surface of the solid support.

The dried reagent compositions positioned on the solid support may be dried dye compositions that, e.g., include a dye. A dried dye composition is a dye composition that includes a low amount of solvent. For example, dried dye compositions may include a low amount of a liquid, such as water. In some cases, a dried dye composition includes substantially no solvent. For instance, dried dye compositions may include substantially no liquid, such as water. In certain embodiments, a dried dye composition includes 25 wt % or less solvent, such as 20 wt % or less, or 15 wt % or less, or 10 wt % or less, or 5 wt % or less, or 3 wt % or less, or 1 wt % or less, or 0.5 wt % or less solvent. In some cases, a dried dye composition is not a fluid. In some cases, a dried dye composition is substantially a solid. For example, a dried dye composition may have a high viscosity, such as a viscosity of 10,000 cP or more, or 25,000 cP or more, or 50,000 cP or more, or 75,000 cP or more, or 100,000 cP or more, or 150,000 cP or more, or 200,000 cP or more, or 250,000 cP or more at standard conditions.

The dried dye compositions may include one or more non-dye materials. When present, the non-dye material is a material compatible with other assay components (e.g., reagents, buffers, analytes, etc.) that may be present in the reagent device during use. The non-dye material may be substantially inert with respect to the other assay components (e.g., reagents, buffers, analytes, etc.) that may be present in the reagent device during use such that there is no significant reaction between the non-dye material and the other assay components. Examples of non-dye materials include, but are not limited to, stabilizers, buffers, soluble inert materials (e.g., aqueous soluble inert materials), and the like. Stabilizers of interest include, but are not limited to: sugars and polyalcohols. Sugars and polyalcohols suitable for use in lyophilized dye compositions include sugars that are compatible with the other reagents, buffers, dyes and sample components being used. Examples of suitable sugars include, but are not limited to, sucrose, maltose, trehalose, 2-hydroxypropyl-beta-cyclodextrin (β-HPCD), lactose, glucose, fructose, galactose, glucosamine, and the like, and combinations thereof. In certain instances, the sugar is a disaccharide. For example, the disaccharide may be sucrose. Examples of suitable polyalcohols include, but are not limited to, mannitol, glycerol, erythritol, threitol, xylitol, sorbitol, and the like, and combinations thereof. Non-dye materials may include, for example, bovine serum albumin (BSA), sodium azide, glycerol, phenylmethanesulfonyl fluoride (PMSF), ethylenediaminetetraacetic acid (EDTA), buffered citrate, phosphate buffered saline (PBS), sodium chloride, paraformaldehyde, and the like, and combinations thereof.

In some instances, the dried dye compositions are lyophilized dye compositions. In certain cases, a lyophilized dye composition is a dye composition where water has been removed from the dye composition by sublimation, where the water in the dye composition undergoes a phase transition from a solid to a gas. For example, a lyophilized dye composition may be a dye composition where water has been removed from the composition by freezing the dye composition (e.g., freezing water in the dye composition) and then reducing the pressure surrounding the dye composition such that the water in the dye composition undergoes sublimation. In certain instances, a lyophilized dye composition includes water in a low amount, such as 25% or less, or 20% or less, or 15% or less, or 10% or less, or 9% or less, or 8% or less, or 7% or less, or 6% or less, or 5% or less, or 4% or less, or 3% or less, or 2% or less, or 1% or less, or 0.5% or less, or 0.25% or less, or 0.1% or less water as measured by Karl Fischer (KF) titration. In some cases, a lyophilized dye composition has 3% or less water as measured by Karl Fischer titration. In some cases, a lyophilized dye composition has 1% or less water as measured by Karl Fischer titration. In some cases, a lyophilized dye composition has 0.5% or less water as measured by Karl Fischer titration. Lyophilized dye compositions may include additives and/or excipients, such as a stabilizer. In some cases, the lyophilized dye composition includes a stabilizer, such as a sugar or a polyalcohol. Sugars and polyalcohols suitable for use in lyophilized dye compositions include sugars that are compatible with the other reagents, buffers, dyes and sample components being used. Examples of suitable sugars include, but are not limited to, sucrose, maltose, trehalose, 2-hydroxypropyl-beta-cyclodextrin (β-HPCD), lactose, glucose, fructose, galactose, glucosamine, and the like, and combinations thereof. In certain instances, the sugar is a disaccharide. For example, the disaccharide may be sucrose. Examples of suitable polyalcohols include, but are not limited to, mannitol, glycerol, erythritol, threitol, xylitol, sorbitol, and the like, and combinations thereof.

As summarized above, the dye in the dye composition may be stably associated with the solid support. By stably associated is meant that the dye does not readily dissociate from the solid support prior to contact with a liquid medium, e.g., an aqueous medium. As such, when present in the container in a dried state (e.g., prior to use in an assay), the dye remains associated with its solid support.

The dye in the dye composition may be used as a detectable label. In certain cases, the dye includes detectable moieties or markers that are detectible based on, for example, fluorescence emission maxima, fluorescence polarization, fluorescence lifetime, light scatter, mass, molecular mass, or combinations thereof. In certain embodiments, the detectable label is a fluorophore (i.e., a fluorescent label, fluorescent dye, etc.). Fluorophores of interest may include, but are not limited to, dyes suitable for use in analytical applications (e.g., flow cytometry, imaging, etc.).

In some instances, the fluorophore (i.e., dye) is a polymeric dye (e.g., a fluorescent polymeric dye). Fluorescent polymeric dyes that find use in the subject methods and systems are varied. In some instances of the method, the polymeric dye includes a conjugated polymer. Conjugated polymers (CPs) are characterized by a delocalized electronic structure which includes a backbone of alternating unsaturated bonds (e.g., double and/or triple bonds) and saturated (e.g., single bonds) bonds, where π-electrons can move from one bond to the other. As such, the conjugated backbone may impart an extended linear structure on the polymeric dye, with limited bond angles between repeat units of the polymer. For example, proteins and nucleic acids, although also polymeric, in some cases do not form extended-rod structures but rather fold into higher-order three-dimensional shapes. In addition, CPs may form “rigid-rod” polymer backbones and experience a limited twist (e.g., torsion) angle between monomer repeat units along the polymer backbone chain. In some instances, the polymeric dye includes a CP that has a rigid rod structure. The structural characteristics of the polymeric dyes can have an effect on the fluorescence properties of the molecules.

Any convenient polymeric dye may be utilized in the subject devices and methods. In some instances, a polymeric dye is a multichromophore that has a structure capable of harvesting light to amplify the fluorescent output of a fluorophore. In some instances, the polymeric dye is capable of harvesting light and efficiently converting it to emitted light at a longer wavelength. In some cases, the polymeric dye has a light-harvesting multichromophore system that can efficiently transfer energy to nearby luminescent species (e.g., a “signaling chromophore”). Mechanisms for energy transfer include, for example, resonant energy transfer (e.g., Forster (or fluorescence) resonance energy transfer, FRET), quantum charge exchange (Dexter energy transfer), and the like. In some instances, these energy transfer mechanisms are relatively short range; that is, close proximity of the light harvesting multichromophore system to the signaling chromophore provides for efficient energy transfer. Under conditions for efficient energy transfer, amplification of the emission from the signaling chromophore occurs when the number of individual chromophores in the light harvesting multichromophore system is large; that is, the emission from the signaling chromophore is more intense when the incident light (the “excitation light”) is at a wavelength which is absorbed by the light harvesting multichromophore system than when the signaling chromophore is directly excited by the pump light.

The multichromophore may be a conjugated polymer. Conjugated polymers (CPs) are characterized by a delocalized electronic structure and can be used as highly responsive optical reporters for chemical and biological targets. Because the effective conjugation length is substantially shorter than the length of the polymer chain, the backbone contains a large number of conjugated segments in close proximity. Thus, conjugated polymers are efficient for light harvesting and enable optical amplification via Forster energy transfer.

Polymeric dyes of interest include, but are not limited to, those dyes described by Gaylord et al. in U.S. Publication Nos. 20040142344, 20080293164, 20080064042, 20100136702, 20110256549, 20110257374, 20120028828, 20120252986, 20130190193, the disclosures of which are herein incorporated by reference in their entirety; and Gaylord et al., J. Am. Chem. Soc., 2001, 123 (26), pp 6417-6418; Feng et al., Chem. Soc. Rev., 2010, 39, 2411-2419; and Traina et al., J. Am. Chem. Soc., 2011, 133 (32), pp 12600-12607, the disclosures of which are herein incorporated by reference in their entirety.

In some embodiments, the polymeric dye includes a conjugated polymer including a plurality of first optically active units forming a conjugated system, having a first absorption wavelength (e.g., as described herein) at which the first optically active units absorbs light to form an excited state. The conjugated polymer (CP) may be polycationic, polyanionic and/or a charge-neutral conjugated polymer.

The CPs may be water soluble for use in biological samples. Any convenient substituent groups may be included in the polymeric dyes to provide for increased water-solubility, such as a hydrophilic substituent group, e.g., a hydrophilic polymer, or a charged substituent group, e.g., groups that are positively or negatively charged in an aqueous solution, e.g., under physiological conditions. Any convenient water-soluble groups (WSGs) may be utilized in the subject light harvesting multichromophores. The term “water-soluble group” refers to a functional group that is well solvated in aqueous environments and that imparts improved water solubility to the molecules to which it is attached. In some embodiments, a WSG increases the solubility of the multichromophore in a predominantly aqueous solution (e.g., as described herein), as compared to a multichromophore which lacks the WSG. The water soluble groups may be any convenient hydrophilic group that is well solvated in aqueous environments. In some cases, the hydrophilic water soluble group is charged, e.g., positively or negatively charged. In certain cases, the hydrophilic water soluble group is a neutral hydrophilic group. In some embodiments, the WSG is a hydrophilic polymer, e.g., a polyethylene glycol, a cellulose, a chitosan, or a derivative thereof.

As used herein, the terms “polyethylene oxide”, “PEO”, “polyethylene glycol” and “PEG” are used interchangeably and refer to a polymer including a chain described by the formula —(CH₂—CH₂—O—)ₙ—, or a derivative thereof. In some embodiments, “n” is 5000 or less, such as 1000 or less, 500 or less, 200 or less, 100 or less, 50 or less, 40 or less, 30 or less, 20 or less, 15 or less, such as 5 to 15, or 10 to 15. It is understood that the PEG polymer may be of any convenient length and may include a variety of terminal groups, including but not limited to, alkyl, aryl, hydroxyl, amino, acyl, acyloxy, and amido terminal groups. Functionalized PEGs that may be adapted for use in the subject multichromophores include those PEGs described by S. Zalipsky, “Functionalized poly(ethylene glycol) for preparation of biologically relevant conjugates”, Bioconjugate Chemistry 1995, 6(2), 150-165. Water soluble groups of interest include, but are not limited to, carboxylate, phosphonate, phosphate, sulfonate, sulfate, sulfinate, ester, polyethylene glycols (PEG) and modified PEGs, hydroxyl, amine, ammonium, guanidinium, polyamine and sulfonium, polyalcohols, straight chain or cyclic saccharides, primary, secondary, tertiary, or quaternary amines and polyamines, phosphonate groups, phosphinate groups, ascorbate groups, glycols, including, polyethers, —COOM′, —SO₃M′, —PO₃M′, —NR₃+, Y′, (CH₂CH₂O)ₚR and mixtures thereof, where Y′ can be any halogen, sulfate, sulfonate, or oxygen containing anion, p can be 1 to 500, each R can be independently H or an alkyl (such as methyl) and M′ can be a cationic counterion or hydrogen, —(CH₂CH₂O)_{yy}CH₂CH₂XR^{yy}, —(CH₂CH₂O)_{yy}CH₂CH₂X—, —X(CH₂CH₂O)_{yy}CH₂CH₂—, glycol, and polyethylene glycol, wherein yy is selected from 1 to 1000, X is selected from O, S, and NR^{ZZ}, and R^{ZZ} and R^{YY} are independently selected from H and C₁₋₃ alkyl.

The polymeric dye may have any convenient length. In some cases, the particular number of monomeric repeat units or segments of the polymeric dye may fall within the range of 2 to 500,000, such as 2 to 100,000, 2 to 30,000, 2 to 10,000, 2 to 3,000 or 2 to 1,000 units or segments, or such as 100 to 100,000, 200 to 100,000, or 500 to 50,000 units or segments.

The polymeric dyes may be of any convenient molecular weight (MW). In some cases, the MW of the polymeric dye may be expressed as an average molecular weight. In some instances, the polymeric dye has an average molecular weight of from 500 to 500,000, such as from 1,000 to 100,000, from 2,000 to 100,000, from 10,000 to 100,000 or even an average molecular weight of from 50,000 to 100,000. In certain embodiments, the polymeric dye has an average molecular weight of 70,000.

In certain instances, the polymeric dye includes the following structure:

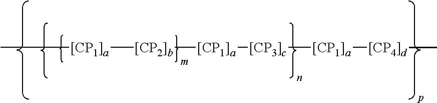

where CP₁, CP₂, CP₃ and CP₄ are independently a conjugated polymer segment or an oligomeric structure, wherein one or more of CP₁, CP₂, CP₃ and CP₄ are bandgap-lowering n-conjugated repeat units, and each n and each m are independently 0 or an integer from 1 to 10,000 and p is an integer from 1 to 100,000.

In some instances, the polymeric dye includes the following structure:

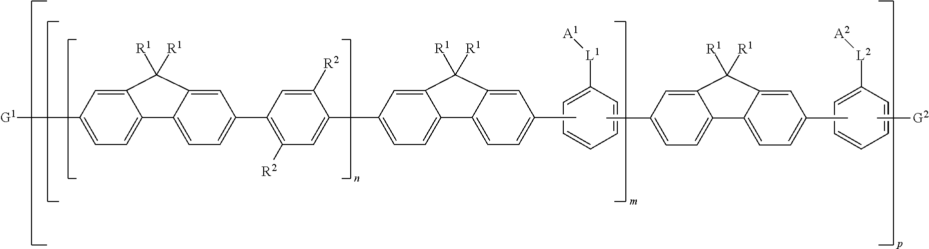

where each R¹ is independently a solubilizing group or a linker-dye; L¹ and L² are optional linkers; each R² is independently H or an aryl substituent; each A¹ and A² is independently H, an aryl substituent or a fluorophore; G¹ and G² are each independently selected from the group consisting of a terminal group, a π-conjugated segment, a linker and a linked specific binding member; each n and each m are independently 0 or an integer from 1 to 10,000; and p is an integer from 1 to 100,000. Solubilizing groups of interest include alkyl, aryl and heterocycle groups further substituted with a hydrophilic group such as a polyethylglycol (e.g., a PEG of 2-20 units), an ammonium, a sulphonium, a phosphonium, and the like.

In some cases, the polymeric dye includes, as part of the polymeric backbone, a conjugated segment having one of the following structures:

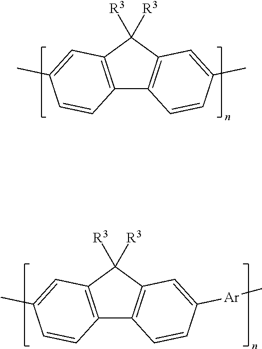

where each R³ is independently an optionally substituted alkyl or aryl group; Ar is an optionally substituted aryl or heteroaryl group; and each n is an integer from 1 to 10,000. In certain embodiments, R³ is an optionally substituted alkyl group. In certain embodiments, R³ is an optionally substituted aryl group. In some cases, R³ is substituted with a polyethyleneglycol, a dye, a chemoselective functional group or a specific binding moiety. In some cases, Ar is substituted with a polyethyleneglycol, a dye, a chemoselective functional group or a specific binding moiety.

In some instances, the polymeric dye includes the following structure:

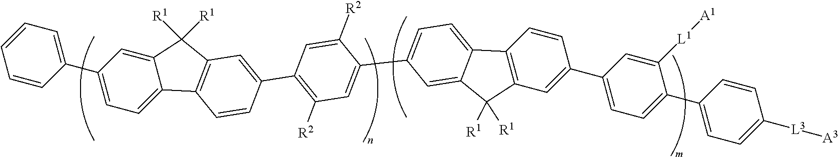

where each R¹ is independently a solubilizing group or a linker-dye group; each R² is independently H or an aryl substituent; each L¹ and L³ are independently optional linkers; each A¹ and A³ are independently H, a fluorophore, a functional group or a specific binding moiety (e.g., an antibody); and n and m are each independently 0 or an integer from 1 to 10,000, wherein n+m>1.

The polymeric dye may have one or more desirable spectroscopic properties, such as a particular absorption maximum wavelength, a particular emission maximum wavelength, extinction coefficient, quantum yield, and the like (see e.g., Chattopadhyay et al., “Brilliant violet fluorophores: A new class of ultrabright fluorescent compounds for immunofluorescence experiments.” Cytometry Part A, 81A(6), 456-466, 2012). In some embodiments, the polymeric dye has an absorption curve between 280 nm and 475 nm. In certain embodiments, the polymeric dye has an absorption maximum (excitation maximum) in the range 280 nm and 475 nm. In some embodiments, the polymeric dye absorbs incident light having a wavelength in the range between 280 nm and 475 nm. In some embodiments, the polymeric dye has an emission maximum wavelength ranging from 400 nm to 850 nm, such as 415 nm to 800 nm, where specific examples of emission maxima of interest include, but are not limited to: 421 nm, 510 nm, 570 nm, 602 nm, 650 nm, 711 nm and 786 nm. In some instances, the polymeric dye has an emission maximum wavelength in a range selected from the group consisting of 410 nm to 430 nm, 500 nm to 520 nm, 560 nm to 580 nm, 590 nm to 610 nm, 640 nm to 660 nm, 700 nm to 720 nm, and 775 nm to 795 nm. In certain embodiments, the polymeric dye has an emission maximum wavelength of 421 nm. In some instances, the polymeric dye has an emission maximum wavelength of 510 nm. In some cases, the polymeric dye has an emission maximum wavelength of 570 nm. In certain embodiments, the polymeric dye has an emission maximum wavelength of 602 nm. In some instances, the polymeric dye has an emission maximum wavelength of 650 nm. In certain cases, the polymeric dye has an emission maximum wavelength of 711 nm. In some embodiments, the polymeric dye has an emission maximum wavelength of 786 nm. In certain instances, the polymeric dye has an emission maximum wavelength of 421 nm±5 nm. In some embodiments, the polymeric dye has an emission maximum wavelength of 510 nm±5 nm. In certain instances, the polymeric dye has an emission maximum wavelength of 570 nm±5 nm. In some instances, the polymeric dye has an emission maximum wavelength of 602 nm±5 nm. In some embodiments, the polymeric dye has an emission maximum wavelength of 650 nm±5 nm. In certain instances, the polymeric dye has an emission maximum wavelength of 711 nm±5 nm. In some cases, the polymeric dye has an emission maximum wavelength of 786 nm±5 nm. In certain embodiments, the polymeric dye has an emission maximum selected from the group consisting of 421 nm, 510 nm, 570 nm, 602 nm, 650 nm, 711 nm and 786 nm.

In some instances, the polymeric dye has an extinction coefficient of 1×10⁶ cm⁻¹M⁻¹ or more, such as 2×10⁶ cm⁻¹M⁻¹ or more, 2.5×10⁶ cm⁻¹M⁻¹ or more, 3×10⁶ cm⁻¹M⁻¹ or more, 4×10⁶ cm⁻¹M⁻¹ or more, 5×10⁶ cm⁻¹M⁻¹ or more, 6×10⁶ cm⁻¹M⁻¹ or more, 7×10⁶ cm⁻¹M⁻¹ or more, or 8×10⁶ cm⁻¹M⁻¹ or more. In certain embodiments, the polymeric dye has a quantum yield of 0.05 or more, such as 0.1 or more, 0.15 or more, 0.2 or more, 0.25 or more, 0.3 or more, 0.35 or more, 0.4 or more, 0.45 or more, 0.5 or more, or even more. In certain cases, the polymeric dye has a quantum yield of 0.1 or more. In certain cases, the polymeric dye has a quantum yield of 0.3 or more. In certain cases, the polymeric dye has a quantum yield of 0.5 or more. In some embodiments, the polymeric dye has an extinction coefficient of 1×10⁶ or more and a quantum yield of 0.3 or more. In some embodiments, the polymeric dye has an extinction coefficient of 2×10⁶ or more and a quantum yield of 0.5 or more.

Specific polymeric dyes that may be employed include, but are not limited to, BD Horizon Brilliant™ Dyes, such as BD Horizon Brilliant™ Violet Dyes (e.g., BV421, BV510, BV605, BV650, BV711, BV786); BD Horizon Brilliant™ Ultraviolet Dyes (e.g., BUV395, BUV496, BUV737, BUV805); and BD Horizon Brilliant™ Blue Dyes (e.g., BB515) (BD Biosciences, San Jose, Calif.).

In certain embodiments, as described above, the reagent insert includes more than one dye composition, such as, for example, two dye compositions (e.g., first and second dye compositions). In these embodiments, the dye compositions can be polymeric dye compositions, as described above. For example, the container may include first and second polymeric dye compositions. As described above, the first and second polymeric dyes may be conjugated polymers (CPs). In certain cases, the first and second polymeric dyes are water soluble conjugated polymers, as described above. In some instance, the dye compositions included in the container may be different dye compositions, such as different polymeric dye compositions. Different dye compositions may differ from each other in terms of chemical composition and/or in terms of one or more properties of the dyes. For instance, different dye compositions may differ from each other by at least one of excitation maxima and emission maxima. In some cases, different dye compositions differ from each other by their excitation maxima. In some cases, different dye compositions differ from each other by their emission maxima. In some cases, different dye compositions differ from each other by both their excitation maxima and emission maxima. As such, in embodiments that include first and second dyes, the first and second dyes may differ from each other by at least one of excitation maxima and emission maxima. For example, the first and second dyes may differ from each other by excitation maxima, by emission maxima, or by both excitation and emission maxima. Additional dye compositions may be included in the container, where each of the dye compositions in the container differ from each other as described above.

In certain embodiments, the dried dye composition includes other types of dye compositions, such as one or more non-polymeric dye compositions. As discussed above, dyes may include detectable moieties or markers that are detectible based on, for example, fluorescence emission maxima, fluorescence polarization, fluorescence lifetime, light scatter, mass, molecular mass, or combinations thereof. In certain embodiments, the non-polymeric dye includes a fluorophore (i.e., a fluorescent label, fluorescent dye, etc.). Fluorophores of interest may include but are not limited to dyes suitable for use in analytical applications (e.g., flow cytometry, imaging, etc.). A large number of non-polymeric dyes are commercially available from a variety of sources, such as, for example, Molecular Probes (Eugene, Oreg.) and Exciton (Dayton, Ohio). For example, the fluorophore of the non-polymeric dye may be 4-acetamido-4′-isothiocyanatostilbene-2,2′disulfonic acid; acridine and derivatives such as acridine, acridine orange, acrindine yellow, acridine red, and acridine isothiocyanate; 5-(2′-aminoethyl)aminonaphthalene-1-sulfonic acid (EDANS); 4-amino-N-[3-vinylsulfonyl)phenyl]naphthalimide-3,5 disulfonate (Lucifer Yellow VS); N-(4-anilino-1-naphthyl)maleimide; anthranilamide; Brilliant Yellow; coumarin and derivatives such as coumarin, 7-amino-4-methylcoumarin (AMC, Coumarin 120), 7-amino-4-trifluoromethylcouluarin (Coumaran 151); cyanine and derivatives such as cyanosine, Cy3, Cy3.5, Cy5, Cy5.5, and Cy7; 4′,6-diaminidino-2-phenylindole (DAPI); 5′, 5″-dibromopyrogallol-sulfonephthalein (Bromopyrogallol Red); 7-diethylamino-3-(4′-isothiocyanatophenyl)-4-methylcoumarin; diethylaminocoumarin; diethylenetriamine pentaacetate; 4,4′-diisothiocyanatodihydro-stilbene-2,2′-disulfonic acid; 4,4′-diisothiocyanatostilbene-2,2′-disulfonic acid; 5-[dimethylamino]naphthalene-1-sulfonyl chloride (DNS, dansyl chloride); 4-(4′-dimethylaminophenylazo)benzoic acid (DABCYL); 4-dimethylaminophenylazophenyl-4′-isothiocyanate (DABITC); eosin and derivatives such as eosin and eosin isothiocyanate; erythrosin and derivatives such as erythrosin B and erythrosin isothiocyanate; ethidium; fluorescein and derivatives such as 5-carboxyfluorescein (FAM), 5-(4,6-dichlorotriazin-2-yl)aminofluorescein (DTAF), 2′7′-dimethoxy-4′5′-dichloro-6-carboxyfluorescein (JOE), fluorescein isothiocyanate (FITC), fluorescein chlorotriazinyl, naphthofluorescein, and QFITC (XRITC); fluorescamine; IR144; IR1446; Green Fluorescent Protein (GFP); Reef Coral Fluorescent Protein (RCFP); Lissamine™; Lissamine rhodamine, Lucifer yellow; Malachite Green isothiocyanate; 4-methylumbelliferone; ortho cresolphthalein; nitrotyrosine; pararosaniline; Nile Red; Oregon Green; Phenol Red; B-phycoerythrin (PE); o-phthaldialdehyde; pyrene and derivatives such as pyrene, pyrene butyrate and succinimidyl 1-pyrene butyrate; Reactive Red 4 (Cibacron™ Brilliant Red 3B-A); rhodamine and derivatives such as 6-carboxy-X-rhodamine (ROX), 6-carboxyrhodamine (R6G), 4,7-dichlororhodamine lissamine, rhodamine B sulfonyl chloride, rhodamine (Rhod), rhodamine B, rhodamine 123, rhodamine X isothiocyanate, sulforhodamine B, sulforhodamine 101, sulfonyl chloride derivative of sulforhodamine 101 (Texas Red), N,N,N′,N′-tetramethyl-6-carboxyrhodamine (TAMRA), tetramethyl rhodamine, and tetramethyl rhodamine isothiocyanate (TRITC); riboflavin; rosolic acid and terbium chelate derivatives; xanthene; carotenoid-protein complexes, such as peridinin-chlorophyll proteins (PerCP); allophycocyanin (APC); or combinations thereof.

In some instances, the dye component of a given dried dye composition is a conjugate of a dye moiety and a specific binding member. The specific binding member and the dye moiety can be conjugated (e.g., covalently linked) to each other at any convenient locations of the two molecules, via an optional linker.

As used herein, the term “specific binding member” refers to one member of a pair of molecules which have binding specificity for one another. One member of the pair of molecules may have an area on its surface, or a cavity, which specifically binds to an area on the surface of, or a cavity in, the other member of the pair of molecules. Thus the members of the pair have the property of binding specifically to each other to produce a binding complex. In some embodiments, the affinity between specific binding members in a binding complex is characterized by a K_{d} (dissociation constant) of 10⁻⁶ M or less, such as 10⁻⁷ M or less, including 10⁻⁸ M or less, e.g., 10⁻⁹ M or less, 10⁻¹⁰ M or less, 10⁻¹¹ M or less, 10⁻¹² M or less, 10⁻¹³ M or less, 10⁻¹⁴ M or less, including 10⁻¹⁵ M or less. In some embodiments, the specific binding members specifically bind with high avidity. By high avidity is meant that the binding member specifically binds with an apparent affinity characterized by an apparent K_{d} of 10×10⁻⁹ M or less, such as 1×10⁻⁹ M or less, 3×10⁻¹⁰ M or less, 1×10⁻¹⁰ M or less, 3×10⁻¹¹ M or less, 1×10⁻¹¹ M or less, 3×10⁻¹² M or less or 1×10⁻¹² M or less. In an embodiment, affinity is determined by surface plasmon resonance (SPR), e.g. as used by Biacore systems. The affinity of one molecule for another molecule is determined by measuring the binding kinetics of the interaction, e.g. at 25° C.

The specific binding member can be proteinaceous. As used herein, the term “proteinaceous” refers to a moiety that is composed of amino acid residues. A proteinaceous moiety can be a polypeptide. In certain cases, the proteinaceous specific binding member is an antibody. In certain embodiments, the proteinaceous specific binding member is an antibody fragment, e.g., a binding fragment of an antibody that specific binds to a polymeric dye. As used herein, the terms “antibody” and “antibody molecule” are used interchangeably and refer to a protein consisting of one or more polypeptides substantially encoded by all or part of the recognized immunoglobulin genes. The recognized immunoglobulin genes, for example in humans, include the kappa (k), lambda (l), and heavy chain genetic loci, which together comprise the myriad variable region genes, and the constant region genes mu (u), delta (d), gamma (g), sigma (e), and alpha (a) which encode the IgM, IgD, IgG, IgE, and IgA isotypes respectively. An immunoglobulin light or heavy chain variable region consists of a “framework” region (FR) interrupted by three hypervariable regions, also called “complementarity determining regions” or “CDRs”. The extent of the framework region and CDRs have been precisely defined (see, “Sequences of Proteins of Immunological Interest,” E. Kabat et al., U.S. Department of Health and Human Services, (1991)). The numbering of all antibody amino acid sequences discussed herein conforms to the Kabat system. The sequences of the framework regions of different light or heavy chains are relatively conserved within a species. The framework region of an antibody, that is the combined framework regions of the constituent light and heavy chains, serves to position and align the CDRs. The CDRs are primarily responsible for binding to an epitope of an antigen. The term antibody is meant to include full length antibodies and may refer to a natural antibody from any organism, an engineered antibody, or an antibody generated recombinantly for experimental, therapeutic, or other purposes as further defined below.

Antibody fragments of interest include, but are not limited to, Fab, Fab′, F(ab′)2, Fv, scFv, or other antigen-binding subsequences of antibodies, either produced by the modification of whole antibodies or those synthesized de novo using recombinant DNA technologies. Antibodies may be monoclonal or polyclonal and may have other specific activities on cells (e.g., antagonists, agonists, neutralizing, inhibitory, or stimulatory antibodies). It is understood that the antibodies may have additional conservative amino acid substitutions which have substantially no effect on antigen binding or other antibody functions.

In certain embodiments, the specific binding member is a Fab fragment, a F(ab′)2 fragment, a scFv, a diabody or a triabody. In certain embodiments, the specific binding member is an antibody. In some cases, the specific binding member is a murine antibody or binding fragment thereof. In certain instances, the specific binding member is a recombinant antibody or binding fragment thereof.

In certain embodiments, the container also includes a calibration standard. The calibration standard may be useful for determining the accuracy of the assay and for ensuring consistency between subsequent assays. In some cases, the calibration standard includes a labelled bead, such as a fluorescently labelled bead. The fluorescently labelled bead may be a standard fluorescently labeled bead that is typically used as a calibration standard. Examples of standard fluorescently labeled beads include, but are not limited to, fluorescently labelled microparticles or nanoparticles. In some cases, the fluorescently labeled beads are configured such that they remain suspended in the assay mixture and do not substantially settle or aggregate. In some embodiments, the fluorescently labeled beads include, but are not limited to, fluorescently labelled polystyrene beads, fluorescein beads, rhodamine beads, and other beads tagged with a fluorescent dye. Additional examples of fluorescently labeled beads are described in U.S. Pat. Nos. 6,350,619; 7,738,094; and 8,248,597, the disclosures of each of which are herein incorporated by reference in their entirety.

In certain embodiments, the dye compositions included in the reagent device include polymeric dye compositions, as described above. In some cases, the dye compositions included in the reagent device include non-polymeric dye compositions, as described above. In some instances, the dye compositions included in the reagent device include both polymeric dye compositions and non-polymeric dye compositions. As described above, the reagent devices may include a plurality of dye compositions as described above, which dye compositions may be identical or distinct. For example, the devices may include two or more, such as three or more, distinct dried polymeric dye compositions and two or more, such as three or more, or four or more, or five or more, distinct non-polymeric dye compositions. In some cases, the device includes three or more distinct polymeric dye compositions and five or more distinct non-polymeric dye compositions.

As described above, the device may include both a polymeric dye composition and a non-polymeric dye composition. In some instances, a polymeric dye composition is mixed with a non-polymeric dye composition. In certain embodiments, the mixture of the polymeric dye composition and the non-polymeric dye composition do not undergo significant dye-dye interactions between the polymeric dye composition and the non-polymeric dye composition. For instance, the fluorescence emission energy of the polymeric dye composition is not significantly quenched by interactions with the non-polymeric dye composition. In some cases, the fluorescence emission energy of the polymeric dye composition is not significantly dissipated by a non-radiative transition. In these embodiments, the detectable fluorescence of the polymeric dye composition is not significantly less than would be expected as compared to the fluorescence of the polymeric dye composition in the absence of the non-polymeric dye composition. Similarly, in some embodiments, the fluorescence emission energy of the non-polymeric dye composition is not significantly quenched by interactions with the polymeric dye composition. For instance, the fluorescence emission energy of the non-polymeric dye composition may not be significantly dissipated by a non-radiative transition. In these embodiments, the detectable fluorescence of the non-polymeric dye composition is not significantly less than would be expected as compared to the fluorescence of the non-polymeric dye composition in the absence of the polymeric dye composition. In such instances, the polymeric and non-polymeric dyes of the mixed composition are stably associated with the same solid support, such that in these instances a given solid support includes two or more, such as three or more, including four or more different dyes, where in some instances only one of the dyes is a polymeric dye.

In certain embodiments, the dye composition includes a dye, such as a polymeric and/or non-polymeric dye, as described above. The dye composition may also include other components, such as, but not limited to a solvent, a buffer, a stabilizer, and the like. For example, the dye composition may include a stabilizer that reduces and/or substantially prevents degradation of the dye in the dye composition. In some cases, the presence of a stabilizer in the dye composition is sufficient to reduce and/or substantially prevent degradation of the dye in the dye composition for a certain period of time, such as 24 hours or more, or 48 hours or more, or 72 hours or more, or 4 days or more, or 5 days or more, or 6 days or more, or 1 week or more, or 2 weeks or more, or 3 weeks or more, or 4 weeks or more, or 2 months or more, or 3 months or more, or 4 months or more, or 5 months or more, or 6 months or more, or 9 months or more, or 1 year or more, or 2 years or more. Examples of stabilizers include, but are not limited to, bovine serum albumin (BSA), sodium azide, glycerol, phenylmethanesulfonyl fluoride (PMSF), and the like. Additional additives may also be present in the composition, such as, additives that preserve cells present in whole blood, e.g., platelet stabilizing factor, and the like. Examples of additives that may be included in the composition are anticoagulants such as ethylenediaminetetraacetic acid (EDTA), buffered citrate, heparin, and the like. The composition may include these additives in a liquid or dried state.

In some cases, the reagent devices facilitate storage of the dye compositions for an extended period of time. For instance, a reagent device may be a storage stable device. In some cases, the dried reagent compositions contained in the device are storage stable dye compositions, where the dye compositions are substantially stable for an extended period of time. By “stable” or “storage stable” or “substantially stable” is meant a dye composition that does not significantly degrade and/or lose activity over an extended period of time. For example, a storage stable dye composition may not have significant loss of fluorescence activity due to degradation of the dye composition over an extended period of time, such as 10% or less loss of fluorescence activity, or 9% or less, or 8% or less, or 7% or less, or 6% or less, or 5% or less, or 4% or less, or 3% or less, or 2% or less, or 1% or less loss of fluorescence activity over an extended period of time. In certain instances, a storage stable dye composition has 5% or less loss of fluorescence activity over an extended period of time. In some cases, a storage stable dye composition substantially retains its fluorescence activity over an extended period of time, such as retains 100% of its activity, or 99% or more, or 98% or more, or 97% or more, or 96% or more, or 95% or more, or 94% or more, or 93% or more, or 92% or more, or 91% or more, or 90% or more, or 85% or more, or 80% or more, or 75% or more of its activity over an extended period of time. For example, a storage stable dye composition may retain 90% or more of its fluorescence activity over an extended period of time. In some cases, a storage stable composition retains 95% or more of its fluorescence activity over an extended period of time. An extended period of time is a period of time such as 1 week or more, or 2 weeks or more, or 3 weeks or more, or 1 month or more, or 2 months or more, or 3 months or more, or 4 months or more, or 6 months or more, or 9 months or more, or 1 year or more, or 1.5 years (e.g., 18 months) or more, or 2 years or more, or 2.5 years (e.g., 30 months) or more, or 3 years or more, or 3.5 years (e.g., 42 months) or more, or 4 years or more, or 4.5 years (e.g., 54 months) or more, or 5 years or more. For instance, an extended period of time may be 6 months or more. In some cases, an extended period of time is 9 months or more. In some cases, an extended period of time is 1 year (e.g., 12 months) or more. In some cases, an extended period of time is 1.5 years (e.g., 18 months) or more. In some cases, an extended period of time is 2 years (e.g., 24 months) or more. In some instances, the extended period of time is 10 years or less, such as 7.5 years or less, including 5 years or less, e.g., 2 years or less.

### Specific Embodiments

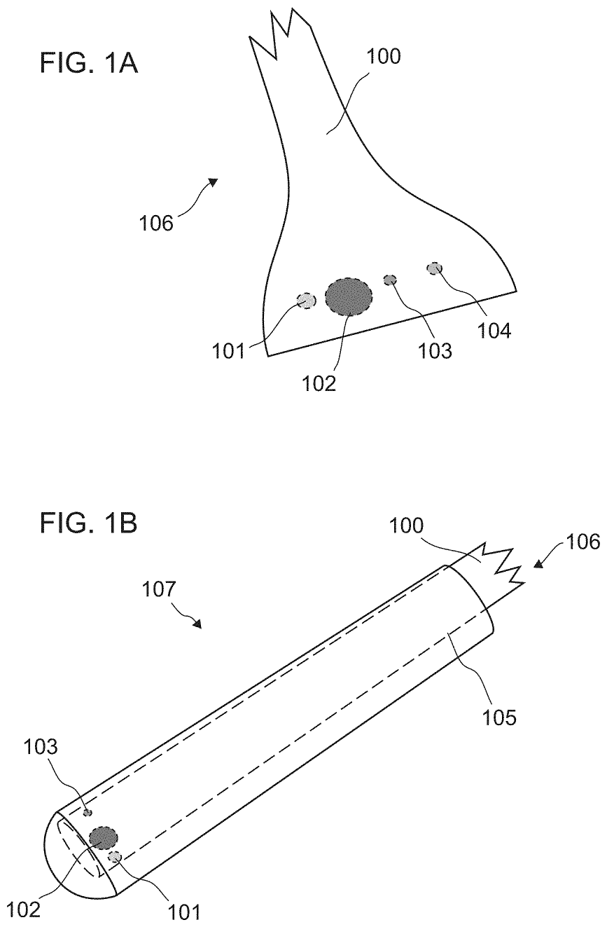

FIGS. 1 A-B provide embodiments of a reagent insert and reagent device including a reagent insert present in a tube. FIG. 1 A shows an embodiment of a reagent insert 106 including dried dye compositions 101, 102, 103, and 104 distinctly positioned on a surface of a solid support 100. Each of the dried dye compositions are spatially separated such that they do not overlap. Dried dye compositions 102 and 103 contain different dyes from each other and from dried dye compositions 101 and 104. The solid support 100 is a flat, flexible sheet of, e.g., of PET (Polyethylene Terephthalate), that may be folded to fit into the internal volume of a tube. FIG. 1 B shows an embodiment of a reagent device 107 that includes a tube 105 and a reagent insert 106 (as shown in FIG. 1 A) present in the tube. The reagent insert 106 includes a solid support 100 having dried dye compositions 101, 102, 103 (and others not shown) positioned on a surface thereof. The solid support 100 is folded such that it fits in the internal volume of the tube 105. The solid support 100 is removable from the tube 105 after rehydration of the dried dye compositions.

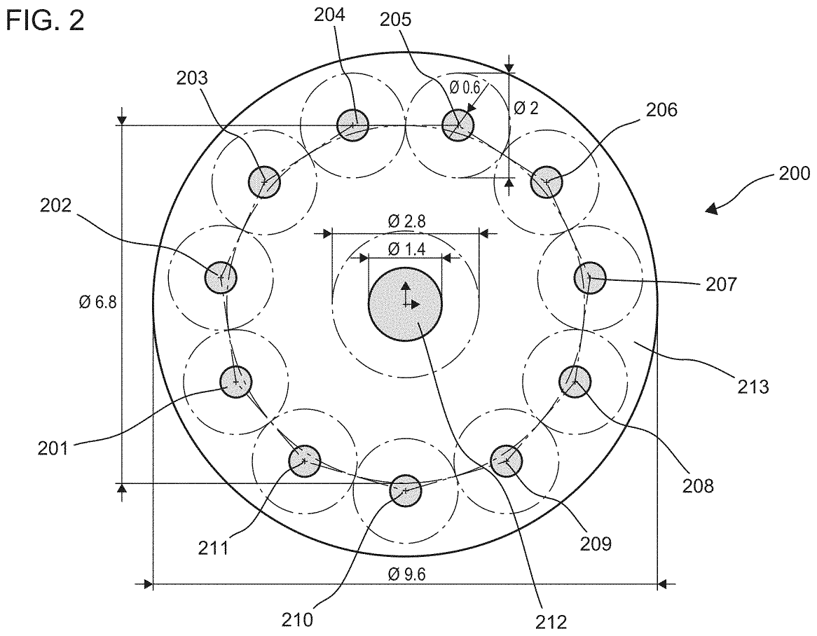

FIG. 2 provides calculations showing the expected spatial separation of eleven distinctly positioned liquid reagent compositions 201-211 and a distinctly positioned liquid cocktail reagent composition 212 on the surface of a solid support 213 of a reagent insert 200 in accordance with one embodiment of the invention. Each of the liquid reagent compositions 201-211 have a volume of 100 nl and may include distinct reagents such as dyes including, e.g., polymeric dyes. The liquid cocktail reagent composition 212 has a volume of 1.5 μl and may include a mixture of eight (or more) distinct reagents such as dyes including, e.g., non-polymeric dyes. The dyes of the liquid cocktail reagent composition do not have dye-dye interactions. The calculations factor in space for droplet drift during dispensing or drying to predict a potential to dispense up to 19 reagents, e.g., dyes, onto one surface of one insert (e.g., 11 spatially separated Becton Dickinson (BD) Horizon™ polymeric dyes (e.g., such as described above) and a cocktail of 8 or more non-polymeric dyes, such as described above).

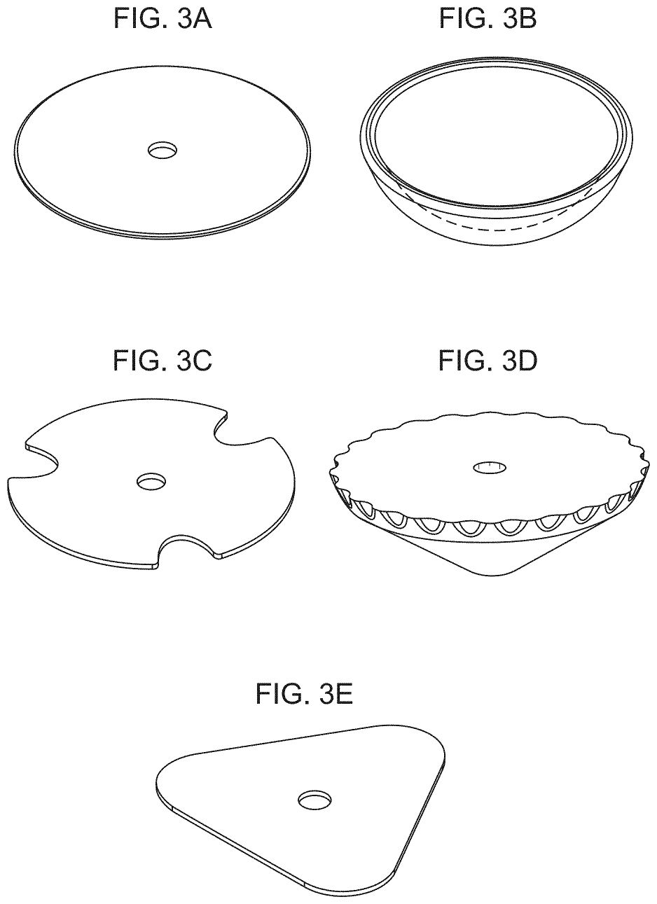

FIGS. 3 A-E provides solid support geometries, according to certain embodiments of the invention. A solid support of a reagent insert may be of a rigid or flexible material and may have a flat or curved surface topography. A secondary substance may be used to help the attachment of the solid support(s) to the inner wall of a FACS tube. The friction contact between a solid support and the internal surface of the tube may keep the solid support in place during the tube's use. A solid support's geometry can be designed so that its edges act like compressed springs against the inner wall of a FACS tube, keeping the solid support in place. A solid support may also use a rubber material at its edges to improve contact and attachment with the internal surface of a FACS tube. A solid support's surface may have a coating applied to alter its material properties and improve dispense adhesion and/or separation. A solid support may be of a plug or retainer style and may prevent liquid passing through or may allow for both liquid and/or a pipette/sample tip to pass through it. The solid support may be configured such that it does not impact the functional operation of a FACS tube. FIG. 3 A shows an exemplary solid support having a flat surface. FIG. 3 B shows an exemplary curved solid support. FIG. 3 C shows an exemplary metal solid support. FIG. 3 D shows an exemplary cone solid support. FIG. 3 E shows an exemplary triangular solid support.

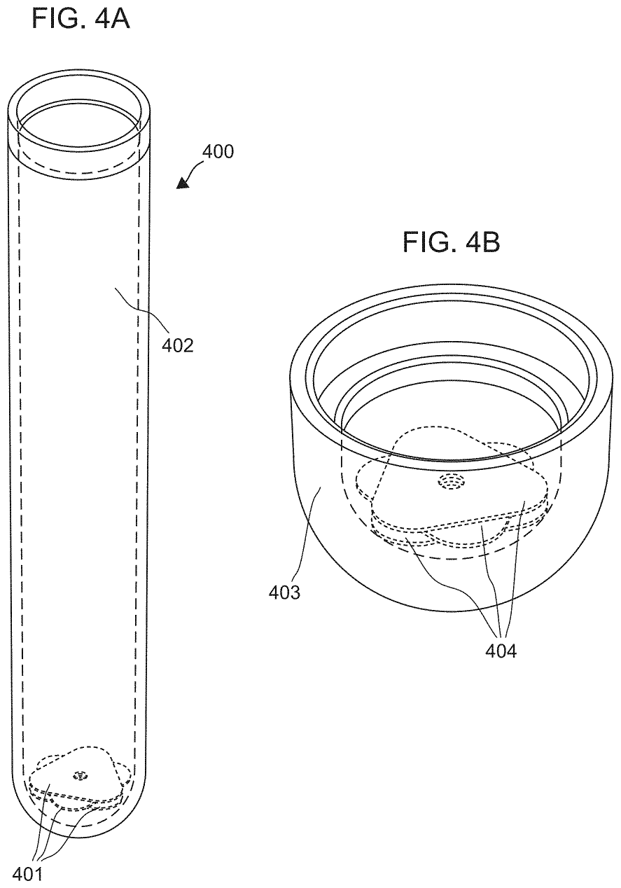

FIGS. 4 A-B show (A) a fully assembled 2-part FACS tube containing multiple reagent inserts and (B) a first volume part of a 2-part FACS tube containing multiple reagent inserts, according to embodiments of the invention. In FIG. 4 A, multiple reagent inserts 401 are positioned at the bottom of a fully assembled 5 mL FACS tube 402. The reagent inserts may be placed in the FACS tube after dispensing of reagents, e.g., dyes, onto one or more surfaces of solid supports of the reagent inserts. Together, the reagent inserts 401 and the tube 402 form a reagent device 400. FIG. 4 B shows multiple reagent inserts 404 present in a first volume part 403 of a 2-part FACS tube. The first volume part 403 may form a bottom portion of a tube when joined with a tube wall portion to form a full FACS tube. An insert may be placed in the first volume part of a 2-part FACS tube after dispensing and drying of reagents onto the surface(s) of a solid support of the insert has been completed. The first volume part may then be joined with a tube wall portion to form a full FACS tube. This method allows for a combination of a 2-part FACS tube and multiple inserts of dried down spatially separated reagents. Alternatively, with the 2-part FACS tube configuration, the insert may also be placed in the tube, i.e., the first volume part, before dispensing reagents on one or more surfaces of a solid support of the insert commences. After dispensing and drying of the reagents onto the surface of the solid support, the first volume portion may be joined with a tube wall portion to form a full FACS tube.

### Method of Making

### Reagent Device

As summarized above, aspects of the present disclosure include methods of making a reagent device as described herein. The methods may produce a fully assembled reagent device including, e.g., a liquid container and a reagent insert present in the liquid container, where the reagent insert includes, e.g., a first dried reagent composition and a second dried reagent composition distinctly positioned on one or more surfaces of a solid support. In practicing embodiments of the methods of making, aspects of the methods include positioning a reagent insert inside a liquid container to produce the reagent device, the reagent insert including a first dried reagent composition and a second dried reagent composition distinctly positioned on one or more surfaces of a solid support. For example, the methods of making may include positioning one or more reagent inserts into a container, e.g., at the bottom of a vial or well, in a bottle, in a dispenser, etc. The reagent insert(s) may be positioned in the container using any convenient protocol, such as, but not limited to, any convenient manual or automated deposition protocol, e.g., dropping the reagent insert into the container, using a placement device to position the reagent insert in the container, etc. The methods may include positioning two or more, three or more, four or more, or five or more solid supports in the liquid container.

In some embodiments, where the fully assembled container includes separate portions, the methods may include producing a fully assembled container, where separate portions of the container are joined. For example, the methods may produce a container having a container bottom portion attached or joined to a container wall portion. The method may include attaching the container bottom portion to a container wall portion to form a liquid seal attachment region joining the container bottom portion to the container wall portion to produce the reagent device. Before attachment, the container wall portion may include an elongated member having open first and second ends separated by a wall. The container bottom portion, e.g., the open end of the container bottom portion, may be attached to the container wall portion at the open first end or the open second end of the container wall portion. The container bottom portion may be attached to the container wall portion by any suitable means. In some instances, the attaching includes press fitting, snap fitting, or screw threading the bottom container portion and the wall container portion to each other. In some instances, the attaching includes solvent bonding, adhesive bonding, or welding the bottom container portion and the wall container portion to each other. In some instances, one or more reagent inserts are present inside the container bottom portion. In some instances, one or more reagent inserts are positioned in the container bottom portion before the container bottom portion is attached or joined to the container wall portion. In some instances, one or more reagent inserts are positioned in the container bottom portion after the container bottom portion is attached or joined to the container wall portion.

In some instances, the methods may further include sealing the container that contains the reagent insert(s). For example, the method may include applying a seal to the liquid container. As described above, the seal may be a water-tight and/or an air-tight seal. In some instances, the seal is a removable or a breakable seal, which allows a user to subsequently gain access to the contents of the container. In certain embodiments, the fully assembled reagent device may be packaged before use in an assay.

As described above, the devices may also include a calibration standard, such as standard fluorescently labelled beads. In these embodiments, the methods may further include positioning a set of standard fluorescently labelled beads in the container. The positioning may be performed using any convenient technique for handling beads. For example, the beads may be provided in a liquid, such as a suspension of beads in a liquid. In these instances, the liquid containing the beads may be positioned in the container using any convenient liquid handling apparatus, such as, but not limited to, syringes, needles, pipets, aspirators, among other liquid handling devices. In some instances, the liquid containing the beads may be positioned on a surface of the container using a printer, such as, but not limited to, an inkjet printer. In these instances, the beads may be positioned and then dried in the container, prior to introduction of the dried dye compositions.

### Reagent Insert

Aspects of the present disclosure also include methods of making a reagent insert as described herein. The methods may produce a reagent insert having one or more dried reagent compositions positioned on one or more surfaces of a solid support. The methods may include positioning one or more liquid reagent compositions on one or more surfaces of a solid support and drying the one or more liquid reagent compositions to produce dried reagent compositions. In practicing embodiments of the methods of making a reagent insert, the methods may include distinctly positioning a first liquid reagent composition and a second liquid reagent composition on one or more surfaces of the solid support and drying the first liquid reagent composition to produce a first dried reagent composition and the second liquid reagent composition to produce a second dried reagent composition to produce the reagent insert.

As summarized above, aspects of the subject methods may include positioning a reagent composition (e.g., a first liquid reagent composition) on a surface of a solid support. In certain embodiments, a liquid reagent composition (e.g., liquid dye composition) is positioned on the surface of the solid support first and then the liquid reagent composition is dried to provide a dried reagent composition on the surface of the solid support. The distinctly positioned liquid reagent composition may be dried to provide a distinctly positioned dried reagent composition on the surface of the solid support. The methods may further include positioning two or more liquid reagent compositions (e.g., first and second liquid reagent compositions) on one or more surfaces of the solid support. In certain embodiments, the method further includes positioning a second liquid reagent composition on a surface of the solid support. The method may further include drying the second liquid reagent composition to produce a second dried reagent composition. In some instances, positioning of first and second liquid reagent compositions on one or more surfaces of a solid support includes depositing the first and second liquid reagent compositions from a liquid handler device onto the one or more surfaces. The liquid reagent composition(s) may be distinctly positioned on the same surface of the solid support or on different surfaces of the solid support.

The method may include positioning two or more liquid reagent compositions on two or more different surfaces of the solid support. In such embodiments, the method may include positioning a first liquid reagent composition on a first surface of the solid support and positioning a second liquid reagent composition on a second surface of the solid support. The method may further include rotating the solid support such that two or more liquid reagent compositions may be positioned on different surfaces of the solid support. For example, a first surface of a solid support may be positioned before a dispense nozzle of a liquid handler such that a first liquid reagent composition may be positioned on the first surface, and the solid support may be rotated to position a second surface before the dispense nozzle of the liquid handler such that a second liquid reagent composition may be positioned on the second surface of the solid support.

In some embodiments, a dye composition may be provided as a liquid dye composition and the liquid dye composition may be distinctly positioned on a surface of the solid support. The distinctly positioned liquid dye composition may be dried to provide a distinctly positioned dried dye composition on the surface of the solid support. The liquid dye composition may be distinctly positioned on the surface of the solid support using any convenient liquid handling apparatus, such as, but not limited to, syringes, needles, pipets, aspirators, among other liquid handling devices. Additional liquid dye compositions may be distinctly positioned on the surface(s) of the solid support. A liquid handling apparatus may be configured to deposit a nanoliter volume of each of the liquid reagent compositions (e.g., first and second liquid reagent compositions). In certain embodiments, the positioning of the reagent compositions includes depositing the liquid reagent compositions (e.g., first and second liquid reagent compositions) from a liquid handler device.

In some instances, the methods include positioning a liquid cocktail reagent composition on a surface of a solid support. Where a liquid reagent composition includes a plurality, e.g., two or more, three or more, including four or more, etc., distinct reagents, it may be referred to as a liquid cocktail reagent composition. Where a given liquid reagent composition includes a plurality, e.g., two or more, such as three or more, including four or more, etc., distinct dyes, it may be referred to as a liquid dye cocktail reagent composition. In some instances, the liquid dye cocktail reagent composition includes two or more distinct non-polymeric dyes. In certain embodiments, the mixture of the non-polymeric dyes in the liquid dye cocktail reagent composition does not undergo significant dye-dye interactions. For instance, the fluorescence emission energy of each of the non-polymeric dyes is not significantly quenched by interactions with other non-polymeric dyes in the same mixture. In some cases, the fluorescence emission energy of each of the non-polymeric dyes is not significantly dissipated by a non-radiative transition. In these embodiments, the detectable fluorescence of the non-polymeric dyes is not significantly less than would be expected as compared to the fluorescence of the non-polymeric dyes in the absence of the other non-polymeric dyes. In some instances, the liquid dye cocktail reagent composition includes one polymeric dye where the polymeric dye does not have dye-dye interactions with the non-polymeric dye(s). The liquid dye cocktail reagent composition may be distinctly positioned on a surface of the solid support, e.g., relative to other liquid or dried reagent compositions positioned on the surface(s) of the solid support.

Any suitable liquid handler or liquid handling device can be used. Suitable liquid handling devices include, e.g., those that are capable of dispensing volumes accurately in the nanoliter range. The devices may be automated, in that they are configured so that at least some, if not all, steps of a given protocol may occur without human intervention, beyond introduction of the liquid components into the device, loading of any requisite reagents and input of information, and activating the device to perform the steps of the method. In some instances, the liquid handling device includes an automated reagent dispenser that is configured to deposit a metered volume of a reagent composition, e.g., a liquid reagent composition, at a distinct location on a solid support. The reagent dispenser may be a contact or non-contact reagent dispenser that can dispense reagent compositions onto a surface with/without contacting the surface. In some instances, the reagent dispenser is configured to be able to individually introduce a metered amount of a liquid reagent composition onto a surface of a solid support, e.g., by dropping an amount of the reagent composition onto the surface of the solid support. In some instances, the reagent dispenser is configured to deposit a metered volume of a liquid dye composition. In some instances, the reagent dispenser includes a reagent metering element (such as a liquid reagent metering unit) operatively coupled to a bulk reagent source (such as a liquid reagent reservoir including, e.g., a pipette tip, a conical tube, a pressurized liquid reagent reservoir, etc). The metering element may measure and dispense discrete volumes of liquid. In some instances, the metering element includes a microfluidic chip having a microfluidic valve cluster which may dispense liquid volumes ranging from, e.g., 100 nl to 5 μl. The valve cluster may have an input valve, an output valve, and two micro-diaphragms. The valves may be opened and closed with pressure and vacuum. The metering element may be transported to different locations by an automated movement arm, e.g., an arm that is configured to move in the X and/or Y and/or Z directions. Liquid handler devices of interest include, but are not limited to, a Mantis® dispenser (Formulatrix, Inc.; Bedford, Mass.). Further details regarding liquid handling systems by Formulatrix, Inc. that may be employed in embodiments of the subject methods are provided in U.S. Pat. Nos. 8,016,260; 8,100,293; 8,205,856; 8,550,298, the disclosures of which are herein incorporated by reference in their entireties. Additional suitable liquid handlers include, for example, Multidrop™ Combi nL Reagent Dispenser (Thermo Fisher Scientific; Catalog number 5840400; Waltham, Mass.); D300e Digital Dispenser (Tecan; Minnedorf, Switzerland); Mosquito® LV and Dragonfly® discovery liquid handlers by SPT Labtech (Melbourne, UK); I-DOT (CeLLINK; Boston, Mass.); Echo® liquid handlers (Beckman Coulter Life Sciences; Pasadena, Calif.); and reagent dispensers including BioJet™, PolyJet™ PolyDrop™, Ultra™, and Rainmaker™ dispense systems from Biodot, Inc., Irvine, Calif. In some instances, a liquid reagent composition may be distinctly positioned on a surface of a solid support using a printer, such as, but not limited to, an inkjet printer. The printer may be configured to dispense liquid volumes, e.g., nanoliter volumes, at precise locations on a surface of a solid support in a non-contact manner. The printer may dispense liquid reagent compositions (e.g., eject a droplet of a liquid reagent composition from a nozzle) by any suitable mechanism including, e.g., piezoelectric actuation, syringe pumps, pneumatic actuation of a diaphragm, etc. In some instances, the solid support is positioned at a distance from a dispense nozzle of the liquid handler device such that one or more liquid reagent compositions having a nanoliter volume may be distinctly positioned on the surface(s) of the solid support. In some instances, the method includes positioning a dispense nozzle of the liquid handler device at a distance from a surface of the solid support ranging from 1 mm to 15 mm including, e.g., from 1 mm to 10 mm or from 1 mm to 5 mm.

A liquid reagent composition that is distinctly positioned on a surface of the solid support may be dried using any convenient drying protocol. In some cases, the drying includes air drying or allowing the liquid reagent composition to dry at room temperature. The air drying may be performed at a temperature ranging, e.g., from 20° C. to 22° C. In some cases, the liquid reagent composition may be heated or placed in an environment at a temperature greater than standard conditions. In certain instances, the temperature is a temperature greater than standard conditions that is sufficient to dry the liquid reagent composition, e.g., liquid dye composition, but less than a temperature that would cause degradation to the reagent composition. For example, the liquid reagent composition may be heated to a temperature ranging from 30° C. to 50° C., such as 30° C. to 45° C. to provide a dried dye composition. In certain embodiments, the temperature is applied to the liquid reagent composition for a time sufficient to dry the composition, such as 1 min or more, or 5 min or more, or 10 min or more, or 15 min or more, or 20 min or more, or 30 min or more. In embodiments that include two or more reagent compositions, e.g., dye compositions, on the surface of the solid support, the different reagent compositions may be positioned and dried on the surface of the solid support sequentially, or each reagent composition may be positioned on the surface of the solid support and all of the reagent compositions may be dried simultaneously. In certain embodiments, the liquid reagent compositions are dried by lyophilization. As used herein in its conventional sense, the term “lyophilization” refers to a freezing and dehydration process. Thus, “conditions for lyophilization” refer to subjecting a liquid material and/or a vessel containing the liquid material to freezing conditions while reducing the surrounding pressure to allow the frozen water within the material to sublimate directly from the solid phase to the gas phase. Such freezing conditions may include cooling the material below the lowest temperature at which the solid and liquid phases thereof can coexist (known in the art as the “triple point”). For lyophilization protocols, separation of uncombined water may be achieved using any convenient freeze-dry protocol. In some instances, the temperature of the composition is rapidly reduced, e.g., to flash freeze the composition, e.g., through contact with liquid nitrogen etc. The resultant flash frozen composition is then lyophilized using standard protocol, resulting in removal of substantially all free water from the composition. As substantially all free water is removed from the compositions, the amount of water present in each of the compositions following the lyophilization step may be less than about 0.1%, such as less than about 0.01% and including less than about 0.001% w/w, such that the compositions are correctly characterized as freeze dried compositions.

The volume of liquid reagent compositions (e.g., first and second liquid reagent compositions) positioned on one or more surfaces of a solid support may vary. In some instances, the liquid reagent compositions have the same volume. In some instances, the liquid reagent compositions have a different volume from one another. In some instances, the volume may range from 1 nl to 1000 ul including, e.g., 1 nl to 900 ul, 1 nl to 800 ul, 1 nl to 700 ul, 1 nl to 600 ul, 1 nl to 500 ul, 1 nl to 400 ul, 1 nl to 300 ul, 1 nl to 200 ul, 1 nl to 100 ul, 10 nl to 900 ul, 10 nl to 800 ul, 10 nl to 700 ul, 10 nl to 600 ul, 10 nl to 500 ul, 10 nl to 400 ul, 10 nl to 300 ul, 10 nl to 200 ul, or 10 nl to 100 ul. In some instances, the volume of each of the liquid reagent compositions positioned on the one or more surfaces of the solid support is a nanoliter volume. The nanoliter volume may range from 1 nl to 1000 nl including, e.g., 1 nl to 900 nl, 1 nl to 800 nl, 1 nl to 700 nl, 1 nl to 600 nl, 1 nl to 500 nl, 1 nl to 400 nl, 1 nl to 300 nl, 1 nl to 200 nl, 1 nl to 100 nl, 10 nl to 900 nl, 10 nl to 800 nl, 10 nl to 700 nl, 10 nl to 600 nl, 10 nl to 500 nl, 10 nl to 400 nl, 10 nl to 300 nl, 10 nl to 200 nl, or 10 nl to 100 nl.

As described herein, the reagent insert may include two or more reagent compositions (e.g., dye compositions) distinctly positioned on one or more surfaces of a solid support. As such, in some cases, the method includes positioning the liquid reagent compositions at separate locations on one or more surfaces of the solid support. In some instances, the method further includes positioning a second liquid reagent composition on a surface of the solid support at a separate location from a first liquid reagent composition. For example, the method may include positioning first and second polymeric dye compositions at separate locations on a surface of the solid support. In another example, the method may include positioning first and second polymeric dye compositions on different surfaces of the solid support (e.g., a first surface and a second surface, respectively). Additional liquid reagent compositions (e.g., dye compositions) may be provided on the surface(s) of the solid support, such as a third polymeric dye composition. In these embodiments, the method may further include distinctly positioning the third liquid reagent composition, e.g., polymeric dye composition, on a surface of the solid support. Additional reagent compositions, e.g., polymeric and/or non-polymeric dye compositions, may also be distinctly positioned on the surface(s) of the solid support.

In certain embodiments, the reagent insert includes two or more reagent compositions (e.g., dye compositions) co-located at the same location of the surface of the solid support. Accordingly, in these embodiments the method may include co-locating the liquid reagent compositions at the same location of the surface of the solid support. In some instances, the method further includes positioning a second liquid reagent composition on a surface of the solid support at a location co-located with the first liquid reagent composition. For example, the method may include co-locating first and second dye compositions (e.g., first and second polymeric dye compositions) at the same location of the surface of the solid support. In some cases, the method also includes positioning a non-dye material between the co-located reagent compositions, e.g., dye compositions. For instance, the method may include positioning a non-dye material between the first and second polymeric dye compositions. Additional reagent compositions (e.g., dye compositions) may be co-located at the same location of the surface of solid support, such as a third polymeric dye composition. In these embodiments, the method may further include distinctly positioning the third liquid reagent composition (e.g., third polymeric dye composition) at the same location of the surface of the solid support. Additional liquid reagent compositions, e.g., polymeric and/or non-polymeric dye compositions, may also be distinctly positioned at the same location of the surface of the solid support.

### Specific Embodiments

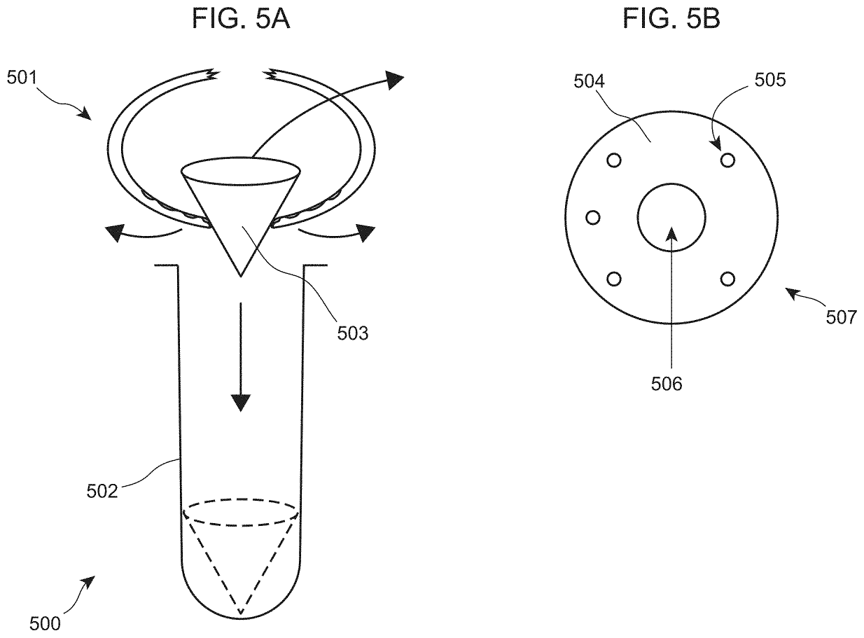

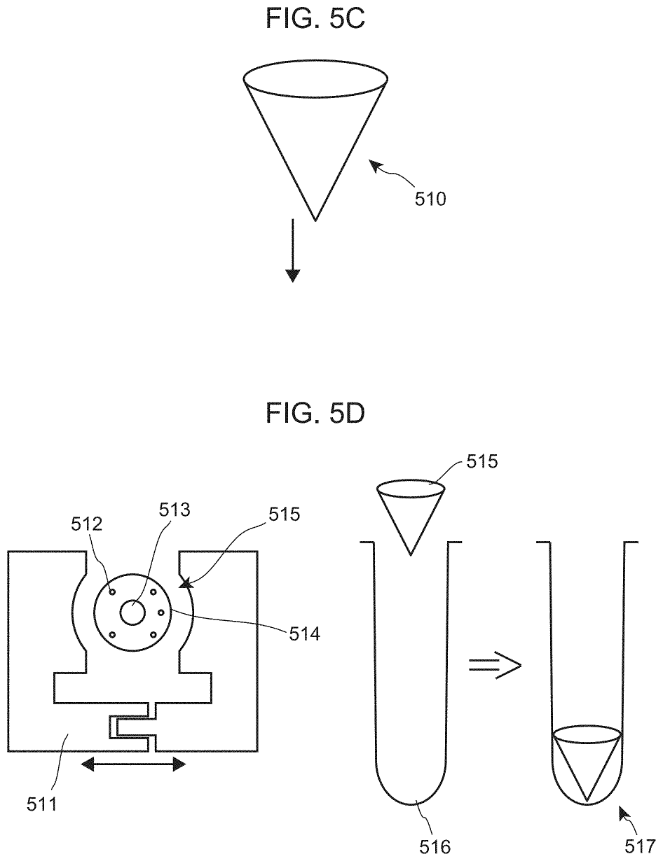

FIGS. 5 A-D show exemplary methods of making a reagent device. FIG. 5 A illustrates an embodiment of a method for positioning a rigid cone-shaped reagent insert 503 into a tube 502 to produce reagent device 500. A robotic arm 501 may hold the reagent insert 503 above the opening of a tube 502 and drop/place the reagent insert 503 into the bottom of the tube 502. Together, the tube 502 and the reagent insert 503 present in the tube form a reagent device 500. FIG. 5 B shows the positions of dried dye compositions on a top surface of a rigid cone-shaped reagent insert 507 according to one embodiment. Distinct dried dye compositions 505 (e.g., BD Horizon Brilliant™ Violet Dyes (e.g., BV421, BV510, BV605, BV650, BV711, BV786)) and a dried dye cocktail composition 506 including two or more distinct dyes are spatially separated on a top surface of a cone-shaped solid support 504. FIG. 5 C provides an embodiment of a rigid cone-shaped reagent insert 510. The cone shape of the rigid reagent insert 510 allows the insert to be positioned at the bottom of a 5 mL FACS tube. The reagent insert 510 may be made from the same material as a 5 mL FACS tube. FIG. 5 D shows an exemplary method of making a reagent insert 515 and positioning the reagent insert in a tube 516 to form a reagent device 517. A robotic arm 511 holds a solid support 514 of the cone-shaped reagent insert 515 during the dispense of distinct dye compositions 512 and a dye cocktail composition 513 onto a surface of the solid support 514. After dispensing and drying of the dye compositions and cocktail composition are complete, the robotic arm 511 releases the reagent insert 515 so that it falls into the bottom of a tube 516 positioned below the insert to form a reagent device 517. The FACS tube is then ready for sample testing with liquid biopsies or dissociated solid tumors.

Many different liquid handlers capable of dispensing volumes accurately in the nanoliter range could be used. Utilizing concentrated manufacturing grade reagents in combination with spatially accurate nanoliter dispensing into a FACS tube, will significantly improve the ability to provide a spatially separated high parameter flow cytometry panel in a FACS tube. The nozzle of the dispensing technology can be placed within a few millimeters of a surface of a solid support of an insert. The liquid reagents are dispensed onto this surface, and following this, they are dried down to improve reagent stability and prolong shelf life. The insert may be rotated so that more reagents can be dispensed onto another surface of the insert. Drying down the wet reagents would again follow this second round of dispensing. The insert may then be manipulated post drying phase to any shape before placement in the tube. As the dispense length is less than 5 mm, it is possible to dispense multiple reagents and keep them spatially separated on a surface of an insert. With the ability to dispense onto multiple surfaces of the insert, and the ability to insert multiple inserts, more surface area is available for dispensing wet reagents. The nanolitre spotting capability, similar to that of the Mantis® by Formulatrix®, opens the opportunity to produce a high parameter panel, consisting of multiple spatially separated reagents, e.g., BD Horizon™ polymeric dyes and non-polymeric dyes, e.g., as described above.

### Method of Use

As summarized above, aspects of the present disclosure also include methods of using the reagent device. As described above, the reagent device may include a liquid container and a reagent insert including a first dried reagent composition and a second dried reagent composition distinctly positioned on one or more surfaces of a solid support. As such, a method of using the reagent device may including reconstituting the dried reagent composition(s). In some instances, the dried reagent compositions are dye compositions, e.g., polymeric dye compositions. The polymeric dye compositions may be dried polymeric dye compositions. As such, the method of using the reagent device may include reconstituting the dye composition. By reconstituting is meant creating a solution by addition of a liquid to a dry material. For example, a liquid may be added to a dried reagent composition, e.g., a dried dye composition, such that the reagent is in solution in the liquid. In certain embodiments, the method includes combining a volume of a liquid and the reagent device or component thereof in a manner sufficient to produce a reconstituted composition, e.g., a reconstituted dye composition. A volume of liquid may be added to the container using any convenient liquid handling apparatus, such as, but not limited to, syringes, needles, pipets, aspirators, among other liquid handling devices. The combining step of the method may include positioning the volume of liquid inside a liquid container. By positioning the volume of liquid inside the liquid container, the liquid may contact the dried polymeric dye compositions in the liquid container. In some cases, the liquid (e.g., water) may be absorbed by the dried dye compositions, thus reconstituting the dried dye compositions.

In practicing embodiments of the subject methods, the methods may include combining a volume of a liquid and a reagent insert including: a first dried reagent composition and a second dried reagent composition distinctly positioned on one or more surfaces of a solid support to produce a reconstituted composition. In some instances, the combining includes introducing the volume of liquid into a liquid container before or after the reagent insert is positioned in the liquid container. For example, a reagent insert may be positioned in a liquid container and a volume of liquid may be introduced in the liquid container containing the reagent insert. In another example, a volume of liquid may be introduced into a liquid container and a reagent insert may be positioned in the liquid container including the volume of liquid. The volume of liquid may contact the dried reagent compositions present on the surface(s) of the solid support, thus reconstituting the reagent compositions.

In certain embodiments, the liquid includes a biological sample. In some cases, the biological sample may be derived from specific biological fluids, such as, but not limited to, blood, mucus, lymphatic fluid, synovial fluid, cerebrospinal fluid, saliva, bronchoalveolar lavage, amniotic fluid, amniotic cord blood, urine, vaginal fluid and semen. In some embodiments, the biological sample includes whole blood or a fraction thereof. In some embodiments, the biological sample includes blood plasma.

In certain embodiments, the container is a sealed container, such as where the container includes a seal (e.g., a water-tight and/or air-tight seal). In these instances, the method may include removing the seal prior to combining, e.g., positioning or introducing, the volume of liquid inside the liquid container. Removing the seal on the container may expose the contents of the liquid container to the surrounding environment and allow access to the interior volume of the liquid container. Thus, a user that has access to the interior volume of the liquid container may position the volume of liquid inside the liquid container for reconstitution of the dried polymeric dye compositions inside the liquid container.

In certain embodiments, the method also includes mixing the contents of the liquid container after positioning the volume of liquid inside the liquid container. The mixing may be performed using any convenient protocol. For example, the mixing may be performed using an agitator. The agitator may be any convenient agitator sufficient for mixing the liquid inside the liquid container, including, but not limited to, vortexers, sonicators, shakers (e.g., manual, mechanical, or electrically powered shakers), rockers, oscillating plates, magnetic stirrers, static mixers, rotators, blenders, mixers, tumblers, orbital shakers, among other agitating protocols.

Where desired, the liquid reconstituted dye composition may be separated from the solid support. In certain embodiments, the method includes separating, e.g., removing, the solid support from the liquid container after combining a volume of liquid with the reagent device, e.g., after introducing a volume of liquid into the liquid container. In such instances, separation may be achieved using any convenient protocol. The solid support may be removed from the reconstituted dye composition using a convenient instrument, such as, e.g., a tweezer. Alternatively, for example, the solid support may be removed from the container, e.g., by pouring it from the container, aspirating it from the container, etc.

In some cases, the method also includes assaying the reconstituted composition, e.g., reconstituted dye composition. Assaying the reconstituted composition, e.g., reconstituted dye composition, may be performed using any suitable assay apparatus. For example, the assay apparatus may be a flow cytometer. In these embodiments, the assaying includes flow cytometrically analyzing the reconstituted composition, e.g., reconstituted dye composition. In some instances, the assaying includes contacting the reconstituted composition, e.g., reconstituted dye composition, with electromagnetic radiation (e.g., light), such as electromagnetic radiation having a wavelength that corresponds to the excitation maxima of the reconstituted composition, e.g., reconstituted dye composition. The assaying may further include detecting emitted light from the excited reagent compositions, e.g., dye compositions. For instance, the method may include detecting emitted light from the excited reagent compositions, e.g., dye compositions, at one or more wavelengths that correspond to the emission maxima of the reagent compositions, e.g., dye compositions.

Suitable flow cytometry systems may include, but are not limited to those described in Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. January; 49(pt 1):17-28; Linden, et. al., Semin Throm Hemost. 2004 October; 30(5):502-11; Alison, et al. J Pathol, 2010 December; 222(4):335-344; and Herbig, et al. (2007) Crit Rev Ther Drug Carrier Syst. 24(3):203-255; the disclosures of which are incorporated herein by reference. In certain instances, flow cytometry systems of interest include BD Biosciences FACSCanto™ II flow cytometer, BD Accuri™ flow cytometer, BD Biosciences FACSCelesta™ flow cytometer, BD Biosciences FACSLyric™ flow cytometer, BD Biosciences FACSVerse™ flow cytometer, BD Biosciences FACSymphony™ flow cytometer BD Biosciences LSRFortessa™ flow cytometer, BD Biosciences LSRFortess™ X-20 flow cytometer and BD Biosciences FACSCalibur™ cell sorter, a BD Biosciences FACSCount™ cell sorter, BD Biosciences FACSLyric™ cell sorter and BD Biosciences Via™ cell sorter BD Biosciences Influx™ cell sorter, BD Biosciences Jazz™ cell sorter, BD Biosciences Aria™ cell sorters and BD Biosciences FACSMelody™ cell sorter, or the like. In certain instances, flow cytometry systems of interest include BD Biosciences FACSCanto™ and FACSCanto II™ flow cytometers, BD Biosciences FACSVantage™, BD Biosciences FACSort™ BD Biosciences FACSCount™, BD Biosciences FACScan™, and BD Biosciences FACSCalibur™ systems, BD Biosciences Influx™ cell sorter, BD Biosciences Accuri™ 06 flow cytometer; BD Biosciences LSRFortessa™ flow cytometer, BD Biosciences LSRFortessa™ X-20 flow cytometer, BD Biosciences FACSVerse™ flow cytometer, BD Biosciences FACSAria™ III and BD FACSAria™ Fusion flow cytometers, BD Biosciences FACSJazz™ flow cytometer, or the like. In certain embodiments, the subject systems are flow cytometric systems, such those described in U.S. Pat. Nos. 3,960,449; 4,347,935; 4,667,830; 4,704,891; 4,770,992; 5,030,002; 5,040,890; 5,047,321; 5,245,318; 5,317,162; 5,464,581; 5,483,469; 5,602,039; 5,620,842; 5,627,040; 5,643,796; 5,700,692; 6,372,506; 6,809,804; 6,813,017; 6,821,740; 7,129,505; 7,201,875; 7,544,326; 8,140,300; 8,233,146; 8,753,573; 8,975,595; 9,092,034; 9,095,494 and 9,097,640; the disclosure of which are herein incorporated by reference in their entirety.

In certain embodiments, the subject flow cytometric systems are configured to sort one or more of the particles (e.g., cells) of the sample. The term “sorting” is used herein in its conventional sense to refer to separating components (e.g., cells, non-cellular particles such as biological macromolecules) of the sample and in some instances delivering the separated components to one or more sample collection containers. For example, the subject systems may be configured for sorting samples having 2 or more components, such as 3 or more components, such as 4 or more components, such as 5 or more components, such as 10 or more components, such as 15 or more components and including sorting a sample having 25 or more components. One or more of the sample components may be separated from the sample and delivered to a sample collection container, such as 2 or more sample components, such as 3 or more sample components, such as 4 or more sample components, such as 5 or more sample components, such as 10 or more sample components and including 15 or more sample components may be separated from the sample and delivered to a sample collection container.

In some embodiments, particle sorting systems of interest are configured to sort particles with an enclosed particle sorting module, such as those described in U.S. Patent Publication No. 2017/0299493, filed on Mar. 28, 2017, the disclosure of which is incorporated herein by reference. In certain embodiments, particles (e.g., cells) of the sample are sorted using a sort decision module having a plurality of sort decision units, such as those described in U.S. patent application Ser. No. 16/725,756, filed on Dec. 23, 2019, the disclosure of which is incorporated herein by reference.

In some embodiments, the flow cytometer systems are flow cytometric systems, such those described in U.S. Pat. Nos. 10,006,852; 9,952,076; 9,933,341; 9,784,661; 9,726,527; 9,453,789; 9,200,334; 9,097,640; 9,095,494; 9,092,034; 8,975,595; 8,753,573; 8,233,146; 8,140,300; 7,544,326; 7,201,875; 7,129,505; 6,821,740; 6,813,017; 6,809,804; 6,372,506; 5,700,692; 5,643,796; 5,627,040; 5,620,842; 5,602,039; the disclosure of which are herein incorporated by reference in their entirety.

Other methods of analysis may also be used, such as, but not limited to, liquid chromatography-mass spectrometry or gas chromatography-mass spectrometry systems. For example, assaying may include the use of an analytical separation device such as a liquid chromatograph (LC), including a high performance liquid chromatograph (HPLC), a micro- or nano-liquid chromatograph or an ultra-high pressure liquid chromatograph (UHPLC) device, a capillary electrophoresis (CE), or a capillary electrophoresis chromatograph (CEC) apparatus. Mass spectrometer (MS) systems may also be used to assay the reagent compositions, e.g., dye compositions. Examples of mass spectrometers may include, but are not limited, to electrospray ionization (ESI), atmospheric pressure chemical ionization (APCI), electron impact (EI), atmospheric pressure photoionization (APPI), matrix-assisted laser desorption ionization (MALDI) or inductively coupled plasma (ICP) ionization, for example, or any combination thereof. Likewise, any of a variety of different mass analyzers may be employed, including time of flight (TOF), Fourier transform ion cyclotron resonance (FTICR), ion trap, quadrupole or double focusing magnetic electric sector mass analyzers, or any hybrid thereof.

In certain embodiments, the container is included in an apparatus that is fully automated. By “fully automated” is meant that the apparatus receives a container and prepares a reconstituted composition, e.g., reconstituted dye composition, with little to no human intervention or manual input into the subject systems. In certain embodiments, the subject systems are configured to prepare and analyze the reconstituted composition, e.g., reconstituted dye composition, without any human intervention.

In certain embodiments, the method also includes storing the reconstituted composition, e.g., reconstituted dye composition, for a period of time. The reconstituted composition, e.g., reconstituted dye composition, may be stored for a period of time before, during and/or after assaying the reconstituted composition, e.g., reconstituted dye composition. In some instances, the reconstituted composition, e.g., reconstituted dye composition, is stored for a period of time such as 24 hours or more, or 48 hours or more, or 72 hours or more, or 4 days or more, or 5 days or more, or 6 days or more, or 1 week or more, or 2 weeks or more, or 3 weeks or more, or 4 weeks or more, or 2 months or more, or 3 months or more, or 4 months or more, or 5 months or more, or 6 months or more, or 9 months or more, or 1 year or more. In certain cases, the reconstituted composition is stored for 24 hours or more. In certain cases, the reconstituted composition is stored for 48 hours or more. In certain cases, the reconstituted composition is stored for 72 hours or more. In certain cases, the reconstituted composition is stored for 1 week or more. In certain cases, the reconstituted composition is stored for 2 weeks or more. In certain cases, the reconstituted composition is stored for 3 weeks or more.

Embodiments of the method may further include shipping the reconstituted composition to a remote location. A “remote location,” is a location other than the location at which the dye composition is reconstituted. For example, a remote location could be another location (e.g., office, lab, etc.) in the same city, another location in a different city, another location in a different state, another location in a different country, etc. As such, when one item is indicated as being “remote” from another, what is meant is that the two items can be in the same room but separated, or at least in different rooms or different buildings, and can be at least one mile, ten miles, or one hundred miles or more apart.

### System

Aspects of the present disclosure also include systems, e.g., for practicing methods of using a reagent device or components thereof as described herein. The systems of the present disclosure may include a reagent device or components thereof according to any of the embodiments described herein. In certain embodiments, the systems include a liquid container and a reagent insert including a first dried reagent composition and a second dried reagent composition distinctly positioned on one or more surfaces of a solid support. In some instances, the reagent insert is separate from the liquid container. In some instances, the reagent insert is present inside the liquid container.

### Utility

The subject reagent devices and methods find use in applications where cell analysis from a biological sample may be desired for research, laboratory testing or for use in therapy. In some embodiments, the subject reagent devices and methods facilitate analysis of cells obtained from fluidic or tissue samples such as specimens for diseases, including but not limited to cancer. Reagent devices and methods of the present disclosure also allow for analyzing cells from a biological sample (e.g., organ, tissue, tissue fragment, fluid) with enhanced efficiency and low cost. The subject reagent devices and methods further may allow for increasing the functional surface area for dispensing distinct reagents and decreasing the dispense height (e.g., between a dispense nozzle and a surface of a solid support), giving greater access to the dispense area.

The subject reagent devices and methods find use in applications where the analysis of a sample using two or more reagents (e.g., dye compositions) is desired. For example, the subject reagent devices and methods find use in applications where the analysis of a sample using two or more polymeric dye compositions is desired. Embodiments of the subject reagent devices and methods also find use in applications where analysis of a sample using two or more polymeric dye compositions in combination with one or more non-polymeric dye compositions is desired. Thus, the subject reagent devices and methods find use in applications where a sample is analyzed for two or more analytes of interest using two or more corresponding polymeric dye compositions. In some cases, where non-polymeric dye compositions are also included in the reagent devices, the subject reagent devices and methods find use in applications where a sample is analyzed for two or more analytes of interest using two or more corresponding polymeric dye compositions and non-polymeric dye compositions. The subject reagent devices may be fully customizable based on the desired application. For example, a research laboratory may order a package or kit of reagent devices with dried down BD Horizon™ Sirigen and Legacy BD dyes of their own choosing, suitable for their exact line of work and with a long shelf life due to the dried down nature of the panel.

The subject reagent devices and methods find use in applications where a minimization in dye-dye interactions is desired. As described herein, embodiments of the subject reagent devices and methods provide two or more dried polymeric dye compositions that are distinctly positioned on one or more surfaces of a solid support. As such, the distinct positioning of the dye compositions relative to each other on the surface of the container bottom portion facilitates a minimization in dye-dye interactions. A minimization in dye-dye interactions may facilitate the collection of more precise and/or accurate data with respect to the assays performed using the subject reagent devices. For instance, the subject reagent devices and methods may facilitate a reduction in dye-dye interactions as compared to containers in which two or more dye compositions are provided but are not distinctly positioned relative to each other.

### Kits

Aspects of the present disclosure also include kits. The kits may include one or more of, e.g., a reagent device or a component thereof according to any of the embodiments described herein. In some instances, the kits include a reagent insert including a first dried reagent composition and a second dried reagent composition distinctly positioned on one or more surfaces of a solid support. In certain embodiments, the kits include one or more reagent inserts including, e.g., two or more, three or more, four or more, or five or more reagent inserts. Where the kits include multiple reagent inserts, the reagent inserts may differ by one or more of the types of solid support (e.g., material, shape, dimensions, etc.), the number of dried reagent compositions positioned on the solid supports, the locations of the dried reagent compositions positioned on the solid supports, and the composition (e.g., reagents, dye composition, formulation, etc.) of the dried reagent compositions positioned on the solid supports. In some instances, the kits include one or more liquid containers. In some embodiments, the one or more reagent inserts are separate from the liquid container(s). In some embodiments, the one or more reagent inserts are present in the liquid container(s).

In certain embodiments, the kit includes a subject reagent device or component thereof and a packaging configured to hold the reagent device or component thereof. The packaging may be a sealed packaging, e.g., a water vapor-resistant container, optionally under an air-tight and/or vacuum seal. In certain instances, the packaging is a sterile packaging, configured to maintain the device enclosed in the packaging in a sterile environment. By “sterile” is meant that there are substantially no microbes (such as fungi, bacteria, viruses, spore forms, etc.). The kits may further include a buffer. For instance, the kit may include a buffer, such as a sample buffer, a wash buffer, an assay buffer, and the like. The kits may further include additional reagents, such as but not limited to, detectable labels (e.g., fluorescent labels, colorimetric labels, chemiluminescent labels, multicolor reagents, avidin-streptavidin associated detection reagents, radiolabels, gold particles, magnetic labels, etc.), and the like. In certain embodiments, the kits may also include a calibration standard. For example, the kits may include a set of labelled beads, such as a set of standard fluorescently labelled beads.

In addition to the above components, the subject kits may further include instructions for practicing the subject methods. These instructions may be present in the subject kits in a variety of forms, one or more of which may be present in the kit. One form in which these instructions may be present is as printed information on a suitable medium or substrate, e.g., a piece or pieces of paper on which the information is printed, in the packaging of the kit, in a package insert, etc. Another means would be a computer readable medium, e.g., CD, DVD, Blu-Ray, computer-readable memory (e.g., flash memory), etc., on which the information has been recorded or stored. Yet another form that may be present is a website address which may be used via the Internet to access the information at a removed site. Any convenient form of instructions may be present in the kits.

The following example(s) is/are offered by way of illustration and not by way of limitation.

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

General methods in molecular and cellular biochemistry can be found in such standard textbooks as Molecular Cloning: A Laboratory Manual, 3rd Ed. (Sambrook et al., HaRBor Laboratory Press 2001); Short Protocols in Molecular Biology, 4th Ed. (Ausubel et al. eds., John Wiley & Sons 1999); Protein Methods (Bollag et al., John Wiley & Sons 1996); Nonviral Vectors for Gene Therapy (Wagner et al. eds., Academic Press 1999); Viral Vectors (Kaplift & Loewy eds., Academic Press 1995); Immunology Methods Manual (I. Lefkovits ed., Academic Press 1997); and Cell and Tissue Culture: Laboratory Procedures in Biotechnology (Doyle & Griffiths, John Wiley & Sons 1998), the disclosures of which are incorporated herein by reference. Reagents, cloning vectors, cells, and kits for methods referred to in, or related to, this disclosure are available from commercial vendors such as BioRad, Agilent Technologies, Thermo Fisher Scientific, Sigma-Aldrich, New England Biolabs (NEB), Takara Bio USA, Inc., and the like, as well as repositories such as e.g., Addgene, Inc., American Type Culture Collection (ATCC), and the like.

### Example 1

A large proportion of liquid handlers use a non-contact droplet dispense to distribute reagents. The positional accuracy of this dispense method is very dependent on the dispense height (distance between dispensing nozzle and target surface). When attempting to dispense reagents/dyes into a FACS tube, the overall height of even the smallest volume tube used for sample analysis makes it very difficult to control the positional accuracy of the dispense to within a reasonable tolerance. This is needed to achieve multiple dispenses of wet reagents, while maintaining reagent separation and preventing dye-to-dye interactions. For example, when dispensing wet reagents with volumes of less than 500 nl into a 5 ml round-bottomed tube, the droplet is likely to make contact with the side of the tube before reaching the tube bottom, and if it does reach the tube bottom, it is almost impossible to ensure it will not touch a previously dispensed wet reagent, causing dye-to-dye interactions. To add to the issue of dispense length, the functional surface area for dispensing in a FACS tube is quite limited when there is a requirement to produce high parameter flow cytometry panels consisting of multiple spatially separated reagents in the nanolitre range. In addition, current technology dispenses at microliter volumes and the dispensing technology used results in reagent wastage from priming the long tubes which supply the dispensing head.

The present work increases the functional surface area for dispensing and drying high parameter flow cytometry reagent panels through the use of FACS tube insert(s). Dispensing and drying down spatially separated reagents onto the surface(s) of an insert creates a high parameter flow cytometry panel. The insert or multiple inserts, which hold reagents dispensed and dried down on its surface, can be placed into a FACS tube. The insert(s) is placed into a FACS tube before or after dispensing. The insert FACS tube can be incubated with patient samples and acquired on a flow cytometer.

Aims of the present work include enabling the use of commercial nanoliter dispensing technology and increasing functional surface area to dispense spatially separated reagents in a FACS tube. The present work, in combination with commercially available dispensing technologies, can be applied to build dried high parameter flow cytometry panels with greater dispensing accuracy, more surface area for dispensing, cheaper reagent cost per unit with less reagent wastage. Reducing the dispense height lowers the risk of droplet drift causing spatial inaccuracies in a non-contact dispense systems. Increasing the functional surface area for reagent dispensing greatly increases the ability to build high parameter flow cytometry panels. Utilizing (e.g., dispensing onto) multiple surfaces of an insert and/or placing multiple inserts in a FACS tube are also examples of how the functional area for dispensing can be increased. Combining this with the surface area available for dispensing in the lower volume of a 2-part FACS tube, the functional surface area can be increased even further. Using an insert or insert(s) to dispense multiple spatially separated dyes allows for integration of alternative dispensing technologies, like the Mantis®, that can dispense in the nanoliter range and greatly reduce losses due to dead volume and cost per dispense. This will enable increased panel complexity whilst significantly reducing reagent wastage compared with prior art.

Materials and Methods

A Mantis® liquid handler device is used to produce a reagent device as shown in FIG. 1 A, as follows: 1. the plastic insert was cut to size and placed in front of the Mantis unit for reagent dispensing, 2. The dyed reagents (water & food coloring) are dispensed from 3 separate reagent chips on the Mantis unit with an automated program, to produce reagent depositions of 200 nl (103), 300 nl (104), 500 nl (101) & 2 μl (102).

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112(6) is not invoked.

1. A reagent device comprising:
a liquid container; and
a reagent insert present in the liquid container, the reagent insert comprising a first dried reagent composition and a second dried reagent composition distinctly positioned on one or more surfaces of a solid support.

2. The reagent device of claim 1, wherein the first and second dried reagent compositions are distinctly positioned on a surface of the solid support.

3. The reagent device of claim 1, wherein the first and second dried reagent compositions are positioned at separate locations on a surface of the solid support.

4-6. (canceled)

7. The reagent device of claim 1, wherein the first dried reagent composition is positioned on a first surface of the solid support and the second dried reagent composition is positioned on a second surface of the solid support.

8-10. (canceled)

11. The reagent device of claim 1, wherein the solid support is stably associated with an inner surface of the liquid container.

12. The reagent device of claim 1, wherein the solid support is stably associated with an inner surface of the liquid container by friction contact between the solid support and the inner surface.

13. The reagent device of claim 1, wherein the solid support is stably associated with an inner surface of the liquid container by compression of one or more edges of the solid support against the inner surface.

14. The reagent device of claim 1, wherein the solid support comprises a substance that stably associates the solid support with an inner surface of the liquid container.

15. The reagent device of claim 1, wherein the solid support comprises a rubber edge.

16. The reagent device of claim 1, wherein the solid support is removable from the liquid container.

27-23. (canceled)

24. The reagent device of claim 1, wherein the solid support is cone shaped.

25. The reagent device of claim 1, wherein a surface of the solid support comprises a coating that modulates a water contact angle of the surface.

26-35. (canceled)

36. The reagent device of claim 1, wherein the first and second dried reagent compositions comprise a dye.

37. The reagent device of claim 36, wherein the dye is a polymeric dye.

38. The reagent device of claim 37, wherein the polymeric dye is a water-soluble conjugated polymer.

39. (canceled)

40. The reagent device of claim 36, wherein the dye is a conjugate of a dye moiety and a specific binding member.

41. The reagent device of claim 40, wherein the specific binding member comprises an antibody or binding fragment thereof.

42. The reagent device of claim 1, wherein the first and second dried reagent compositions are adhered to the one or more surfaces of the solid support.

43-51. (canceled)

52. The reagent device of claim 1, wherein the liquid container comprises a container bottom portion defining a first volume, and a container wall portion attached to the container bottom portion at a sealed attachment region joining the container bottom portion to the container wall portion.

53. The reagent device of claim 52, wherein the container bottom portion comprises a closed end and a wall rising therefrom.

54-437. (canceled)
